(19) United States
(12) Patent Application Publication
(10) Pub. No.: US 2026/0259638 A1
(43) Pub. Date: Sep. 3, 2026

(54) METHOD AND SYSTEM FOR AUTOMATICALLY GENERATING AND RENDERING A WIDGET ON A PERSONALIZED ANALYTICS DASHBOARD BASED ON RECURRING NATURAL LANGUAGE REQUESTS

(71) Applicant: AUTOMATION ANYWHERE, INC., San Jose, CA (US)

(72) Inventor: Ajit KUMAR, San Jose, CA (US)

(21) Appl. No.: 19/657,356

(22) Filed: Apr. 24, 2026

(51) Int. Cl. G06F 3/04817; G06F 16/334

(52) U.S. Cl. CPC G06F 3/04817; G06F 16/3344; G06F 16/3347

(57) ABSTRACT

A method and system for configuring a personalized analytics dashboard receives a natural language request via a conversational user interface. An NLP engine generates a structured intent by resolving natural language expressions against an analytics data model into one or more identifiers. A promotion engine stores the structured intent, the natural language request, and a vector representation in a per-user usage history maintained across user sessions independently of session termination. Whether a recurrence threshold is met is determined by evaluating prior requests using a similarity score between vector representations or a comparison of identifiers of structured intents. The recurrence threshold is indicative of a recurring analytical need across user sessions. When the recurrence threshold is met, a widget definition object is generated, and a dashboard configuration is updated to render a widget by executing a query against an analytics backend without re-executing the natural language processing engine.

### FIELD OF INVENTION

The present invention relates to the field of conversational analytics and more particularly to a method and system for automatically generating and rendering a widget on a personalized analytics dashboard based on recurring natural language requests.

### BACKGROUND

Enterprise analytics platforms present data to users through dashboard interfaces that display widgets representing various metrics and key performance indicators. In multi-tenant software-as-a-service environments, these dashboards serve as the primary mechanism through which users access operational data, monitor business processes, and derive insights from underlying data stores. In such environments, analytics dashboards present a fixed set of pre-configured widgets to users based on role or tenant assignments. The dashboard configuration is established in advance and does not adapt to the data access patterns of individual users. The configuration process involves maintaining dashboard state, executing queries against data stores, and rendering visual components that present the retrieved data in formats appropriate for the underlying metrics being displayed.

Current approaches to dashboard configuration rely on static, pre-configured widget assignments or manual configuration workflows. In static assignment approaches, a system maintains a fixed set of widget definition objects associated with user roles or tenant configurations, and the system renders these predetermined widgets regardless of individual user data access patterns. In manual configuration approaches, users submit requests through administrative interfaces or support channels, and developers or administrators create widget definition objects through development cycles that involve code changes, testing, and deployment operations. Existing systems that incorporate domain-aware semantic parsing and schema completion techniques generate widget specifications from individual natural language queries without retaining user query behavior across sessions. Such systems treat each query as an independent input and cannot leverage accumulated query patterns to automatically configure a persistent dashboard widget, requiring the user to repeatedly submit the same natural language request each session to access recurring operational data.

Current conversational analytics systems present several technical limitations in computer architecture and resource utilization. First, these systems operate on a session-stateless architecture that treats each natural language request as an independent, isolated operation, discarding session state upon session termination. This architectural limitation prevents the existing systems from detecting recurring data access patterns across user sessions. Second, dashboard configuration in existing systems relies on either static pre-configured widget assignments that cannot adapt to individual user behavior, or manual configuration workflows that require developer intervention, code changes, testing, and deployment cycles introducing significant latency between user data needs and dashboard updates. Third, because existing conversational systems cannot recognize recurring analytical needs, users who repeatedly query the same underlying metrics must re-submit natural language requests in each session, causing redundant execution of the natural language processing pipeline and analytics backend queries for data the user accesses regularly. This repeated processing consumes computational resources unnecessarily and increases response latency for frequently accessed metrics.

### SUMMARY

This summary is provided to introduce a selection of concepts in a simplified form that are further described in the detailed description. This summary is not intended to identify key features or essential features of the claimed subject matter, nor is it intended to be used as an aid in determining the scope of the claimed subject matter.

According to an aspect of the present disclosure, a computer-implemented method of automatically generating and rendering a widget on a personalized analytics dashboard is provided. The method may include receiving, via a conversational user interface presented on a client device, a natural language request from a user. A natural language processing (NLP) engine may generate a structured intent from the natural language request by mapping natural language expressions to one or more identifiers defined in an analytics data model.

A promotion engine may store the structured intent, the natural language request, and a vector representation of the natural language request in a per-user usage history maintained across user sessions.

The promotion engine may determine whether a recurrence threshold is met by evaluating one or more prior requests stored in the per-user usage history against the structured intent. The evaluating may comprise at least one of: computing a similarity score between the vector representation of the natural language request and vector representations of prior requests, or comparing identifiers of the structured intent of the current request against identifiers of the structured intent of prior requests. Satisfaction of the recurrence threshold may be indicative of a recurring analytical need of the user across sessions. The evaluation may be performed independently of the termination of any individual user session.

In response to determining that the recurrence threshold is met, the promotion engine may generate a widget definition object based on the structured intent. The promotion engine may further update a dashboard configuration of the user to include the widget definition object such that, on a subsequent dashboard access, a widget is rendered by executing a query referenced in the widget definition object against an analytics backend, without reprocessing the natural language request by the natural language processing engine.

According to another aspect of the present disclosure, a system for automatically generating and rendering a widget to a personalized analytics dashboard is provided. The system comprises one or more processors and a memory storing instructions that, when executed by the one or more processors, cause the system to receive, via a conversational user interface presented on a client device, a natural language request from a user. A natural language processing engine may generate a structured intent from the natural language request by mapping natural language expressions to one or more identifiers defined in an analytics data model. A promotion engine may store the structured intent, the natural language request, and a vector representation of the natural language request in a per-user usage history maintained across user sessions. The promotion engine may determine whether a recurrence threshold is met by evaluating one or more prior requests stored in the per-user usage history against the structured intent, wherein the evaluating may comprise at least one of computing a similarity score between vector representations or comparing identifiers of the structured intent across prior requests. Satisfaction of the recurrence threshold may be indicative of a recurring analytical need of the user across user sessions, and the evaluation may be performed independently of termination of any individual user session. In response to determining that the recurrence threshold is met, the promotion engine may generate a widget definition object based on the structured intent and may update a dashboard configuration of the user to include the widget definition object such that, on a subsequent dashboard access, a widget is rendered by executing a query referenced in the widget definition object against an analytics backend without reprocessing the natural language request by the natural language processing engine.

According to yet another aspect of the present disclosure, a non-transitory computer-readable medium storing instructions is provided. The instructions, when executed by one or more processors, cause the one or more processors to perform operations for automatically generating and rendering a widget to a personalized analytics dashboard. The operations include receiving, via a conversational user interface presented on a client device, a natural language request from a user. A natural language processing engine may generate a structured intent from the natural language request by mapping natural language expressions to one or more identifiers defined in an analytics data model. A promotion engine may store the structured intent, the natural language request, and a vector representation of the natural language request in a per-user usage history maintained across user sessions. The promotion engine may determine whether a recurrence threshold is met by evaluating one or more prior requests stored in the per-user usage history against the structured intent, wherein the evaluating may comprise at least one of computing a similarity score between vector representations or comparing identifiers of the structured intent across prior requests. Satisfaction of the recurrence threshold may be indicative of a recurring analytical need of the user across user sessions, and the evaluation may be performed independently of termination of any individual user session. In response to determining that the recurrence threshold is met, the promotion engine may generate a widget definition object based on the structured intent and may update a dashboard configuration of the user to include the widget definition object such that, on a subsequent dashboard access, a widget is rendered by executing a query referenced in the widget definition object against an analytics backend without reprocessing the natural language request by the natural language processing engine.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a system environment for automatically generating and deploying a widget on a personalized analytics dashboard based on recurring natural language requests, according to an embodiment of the present disclosure.

FIG. 1B illustrates a block diagram of a server of FIG. 1A, according to an embodiment of the present disclosure.

FIG. 1C illustrates a block diagram of the natural language processing engine of FIG. 1A, according to an embodiment of the present disclosure.

FIG. 1D illustrates a block diagram of the analytics backend of FIG. 1A, according to an embodiment of the present disclosure.

FIG. 2 illustrates a flowchart of a method for automatically generating and rendering a widget on the personalized analytics dashboard based on recurring natural language requests, according to an embodiment of the present disclosure.

FIG. 3 illustrates an exemplary conversational user interface of the system, according to an embodiment of the present disclosure.

FIG. 4 illustrates an exemplary personalized analytics dashboard interface, according to an embodiment of the present disclosure.

FIG. 5 illustrates a flowchart of a process of the method for determining recurrence of user requests using similarity scoring, according to an embodiment of the present disclosure.

FIG. 6 illustrates a flowchart of a process of the method for determining recurrence of user requests using schema-grounded identifier matching, according to an embodiment of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Existing conversational analytics systems treat each natural language request as an independent and isolated request, and do not provide a mechanism for automatically configuring a personalized analytics dashboard of a user based on recurring analytical needs observed from conversational behavior over time.

A method and system for automatically generating and rendering a widget on a personalized analytics dashboard based on recurring natural language requests are disclosed. The disclosed method and system receive a natural language request from a user via a conversational user interface presented on a client device and generate a structured intent from the natural language request by resolving natural language expressions in the natural language request against an analytics data model, using a natural language processing engine. The structured intent comprises one or more identifiers defined in the analytics data model. The natural language processing engine operates as a per-request semantic layer that resolves each natural language request to a structured intent against the analytics data model. The promotion engine operates as a persistent behavioral layer that evaluates structured intents of requests across user sessions to detect recurring analytical needs independently of the natural language expressions used in individual requests and independently of termination of any individual user session.

The promotion engine determines whether a recurrence threshold is met by evaluating one or more prior requests of the user stored in a per-user usage history maintained across user sessions against the structured intent. The per-user usage history stores the structured intent, the natural language request, and a vector representation of the natural language request for each request of the user. The promotion engine evaluates the one or more prior requests against the structured intent using a similarity score computed between the vector representation of the natural language request and one or more vector representations corresponding to the one or more prior requests. In alternative implementation, the promotion engine evaluates the one or more prior requests based on comparison of the one or more identifiers of the structured intent against the one or more identifiers of structured intents of the one or more prior requests. Satisfaction of the recurrence threshold is indicative of a recurring analytical need of the user across user sessions.

When the recurrence threshold is met, the promotion engine generates a widget definition object based on the structured intent and the system updates the dashboard configuration of the user to include the widget definition object. In an embodiment, the promotion engine presents a recurrence notification to the user via the conversational user interface upon determining that the recurrence threshold is met and generates the widget definition object in response to receiving an affirmative response to the recurrence notification. A widget is rendered on a personalized analytics dashboard of the user on a subsequent dashboard-access based on the widget definition object. The widget is rendered by executing a query referenced in the widget definition object against an analytics backend without re-executing the natural language processing engine.

The disclosed method and system provide technical advances in computational efficiency, memory utilization, latency reduction, and session-persistent behavioral intelligence. These advances are enabled by the architecture of the promotion engine operating as a persistent behavioral layer that converts ephemeral per-request conversational interactions into normalized structured representations accumulated across user sessions independently of session termination. As recurring analytical needs are detected from this accumulated history, the system automatically triggers dashboard configuration without requiring repeated natural language processing, manual configuration, or developer intervention. Promoting a recurring analytical need for a persistent widget definition object eliminates repeated execution of the natural language processing pipeline, and analytics backend queries for data the user accesses regularly.

Each subsequent dashboard access retrieves data through a query referenced in the widget definition object rather than initiating a new natural language processing cycle, reducing per-session computational overhead and response latency. The persistent behavioral layer of the promotion engine enables pattern detection across user sessions that stateless prior art conversational systems cannot perform, as such systems discard session state on session termination, and treat each request as an isolated operation independent of prior user behavior.

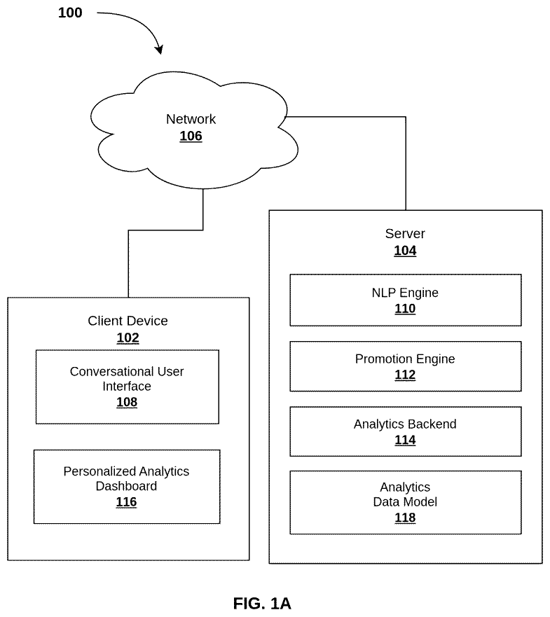

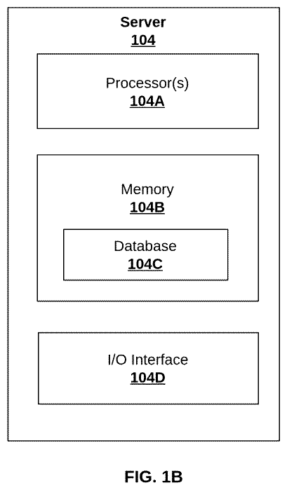

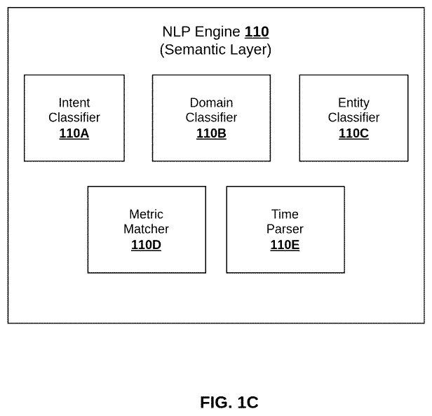

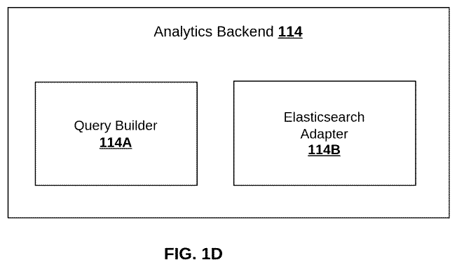

FIG. 1A illustrates a system environment 100 for automatically generating and rendering a widget on a personalized analytics dashboard 116 based on recurring natural language requests. The system environment 100 comprises a client device 102, a server 104, and a network 106. The client device 102 and the server 104 communicate over the network 106. The network 106 may include one or more of a local area network (LAN), a wide area network (WAN), or the Internet. The client device 102 hosts a conversational user interface 108 and the personalized analytics dashboard 116. The conversational user interface 108 provides a display area through which a user associated with a tenant of a multi-tenant software platform submits a natural language request directed to operational or business data. The personalized analytics dashboard 116 presents dashboard elements to the user based on a dashboard configuration associated with the user.

The server 104 comprises a natural language processing (NLP) engine 110, a promotion engine 112, an analytics backend 114, and an analytics data model 118. The analytics data model 118, also referred to in some implementations as a metadata registry, is a predefined reference structure that defines the permitted metric types, filter conditions, time windows, and tenant scope identifiers accessible within the multi-tenant software platform. The server 104 may be configured to receive the natural language request from the user via the conversational user interface 108 on the client device 102 over the network 106. On receiving the natural language request, the server 104 initiates processing of the natural language request through the NLP engine 110.

The NLP engine 110, also referred to as an NLP semantic layer, may be configured to generate a structured intent from the natural language request by mapping natural language expressions in the natural language request to one or more identifiers defined in the analytics data model 118. The structured intent is a machine-readable representation of the natural language request comprising the one or more identifiers defined in the analytics data model 118 that include a metric type, one or more filter conditions, a time window, and a scope derived from a tenant or user context, each expressed as one or more identifiers defined in the analytics data model 118. The NLP engine 110 operates as a per-request semantic layer that resolves each natural language request to a structured intent independently of prior requests. The internal architecture of the NLP engine 110 is further described with reference to FIG. 1C.

The analytics data model 118 is accessible to both the NLP engine 110 and the promotion engine 112. The NLP engine 110 resolves natural language expressions against the analytics data model 118 to produce the structured intent. The promotion engine 112 accesses the analytics data model 118 to evaluate structured intents of prior requests against the current structured intent when determining whether prior requests correspond to a recurring analytical need. The analytics backend 114 accesses the analytics data model 118 through a query builder to construct queries against the underlying data store. The internal architecture of the analytics backend 114 is further described with reference to FIG. 1D.

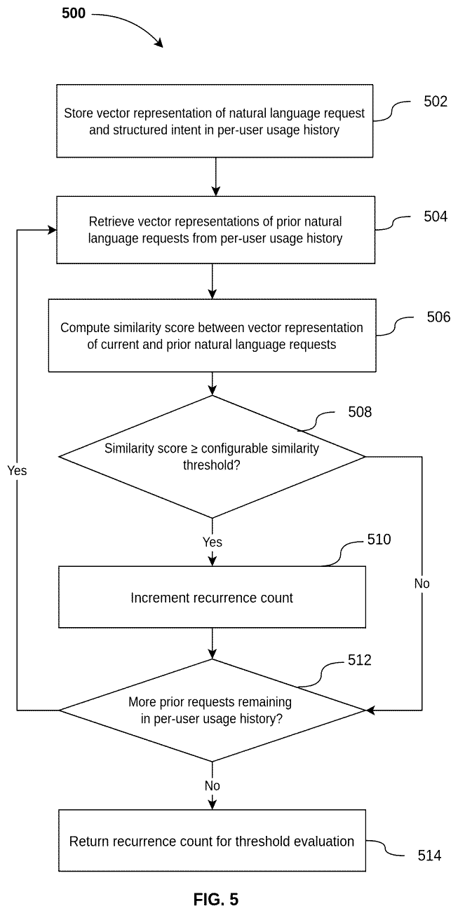

The promotion engine 112 may be configured to store the structured intent, the natural language request, and a vector representation of the natural language request in a per-user usage history maintained across user sessions. The vector representation encodes the semantic content of the natural language request in a form that enables computation of a similarity score between the current natural language request and prior natural language requests stored in the per-user usage history In some implementations, the vector representation may be generated using a sentence embedding model, a transformer-based encoder, an averaged token embedding representation, a term-frequency/inverse-document-frequency representation, or another machine-readable semantic encoding technique. A sentence embedding model or transformer-based encoder may be used when higher semantic precision is desired to capture meaning across varied natural language expressions having low lexical overlap. An averaged token embedding representation may be used where lower computational cost or reduced processing latency is preferred, for example in higher-volume tenant environments or where natural language requests follow more predictable patterns. A term-frequency inverse-document-frequency representation may be used where the analytical vocabulary of the tenant environment is domain-specific and sufficiently consistent that keyword frequency reflects semantic similarity between requests. In each case, the selected technique generates the vector representation encoding semantic content of the natural language request in a form suitable for computing the similarity score. The promotion engine 112 may be further configured to determine whether a recurrence threshold is met by evaluating one or more prior requests of the user stored in the per-user usage history against the structured intent. The promotion engine 112 evaluates the one or more prior requests using at least one of the two techniques. The first technique may include the similarity score between the vector representation of the natural language request and one or more vector representations corresponding to the one or more prior requests. The second technique may use a comparison of the one or more identifiers of the structured intent against the one or more identifiers of structured intents of the one or more prior requests. In some implementations, the similarity score may comprise cosine similarity, dot product similarity, or another vector-space similarity measure computed over the vector representations. The similarity score computation may be further understood in conjunction with FIG. 5.

The recurrence threshold is a configurable value representing a minimum count of prior requests determined to correspond to the recurring analytical need, the satisfaction of which is indicative of a recurring analytical need of the user across user sessions. The recurrence threshold may be set by a tenant administrator based on the operational requirements and usage patterns of the tenant. A lower recurrence threshold, such as two or three, is appropriate for tenants where operational data needs are well defined and a small number of repeated requests across distinct sessions reliably indicates a genuine recurring need. A higher recurrence threshold is appropriate for tenants with larger user populations or more exploratory usage patterns where a greater frequency of recurrence provides a stronger signal before automatic dashboard configuration is triggered. For example, the recurrence threshold may be set to three, such that a user who submits natural language requests corresponding to the same recurring analytical need across three distinct sessions triggers automatic generation of the widget definition object and update of the dashboard configuration. The promotion engine 112 operates as a persistent behavioral layer evaluating conversational behavior across user sessions independently of termination of any individual user session, distinct from the per-request operation of the NLP engine 110.

The promotion engine 112 may be configured to generate a widget definition object when the recurrence threshold is met. The analytics backend 114 may be configured to execute a query referenced in the widget definition object against the underlying data store and retrieve data for rendering on the personalized analytics dashboard 116. The server 104 may be configured to update the dashboard configuration of the user to include the widget definition object such that, on a subsequent dashboard access a widget is rendered by executing the query referenced in the widget definition object against the analytics backend 114 without reprocessing the natural language processing engine 110. As used herein, resolving natural language expressions against the analytics data model 118 refers to the process by which the NLP engine 110 maps each natural language expression in the natural language request to a corresponding identifier defined in the analytics data model 118 through schema-grounded semantic parsing. This includes matching or mapping the natural language expression to a corresponding canonical identifier, field, aggregation type, attribute value, or time range representation defined in the analytics data model 118, such that the output is a machine-readable structured intent rather than unstructured text. In an embodiment, the server 104 resolves the user identity and associated role by extracting an authentication token transmitted alongside the natural language request from the client device 102 and applies the retrieved role and permissions to validate the structured intent against one or more guardrail policies prior to generating the widget definition object.

In some implementations, the server 104 is provisioned with computing resources sufficient to process natural language requests, recurrence evaluation, query construction, and widget generation in near real time for multiple tenants of the multi-tenant software platform. The server 104 may further interact with one or more secured data stores that persist per-user usage history, widget definition objects, and dashboard configuration records in association with tenant identifiers and user identifiers, such that cross-tenant access is prevented and integrity of stored widget configuration data is maintained. In some implementations, communications between the conversational user interface 108, the server 104, and the analytics backend 114 are authenticated and access-controlled based on tenant-specific guardrail policies and user roles. The analytics backend 114 and promotion engine 112 may further perform validation, timeout handling, and retry or error-state recording during query execution and widget generation, thereby improving system reliability during automated generation and rendering of personalized dashboard widgets.

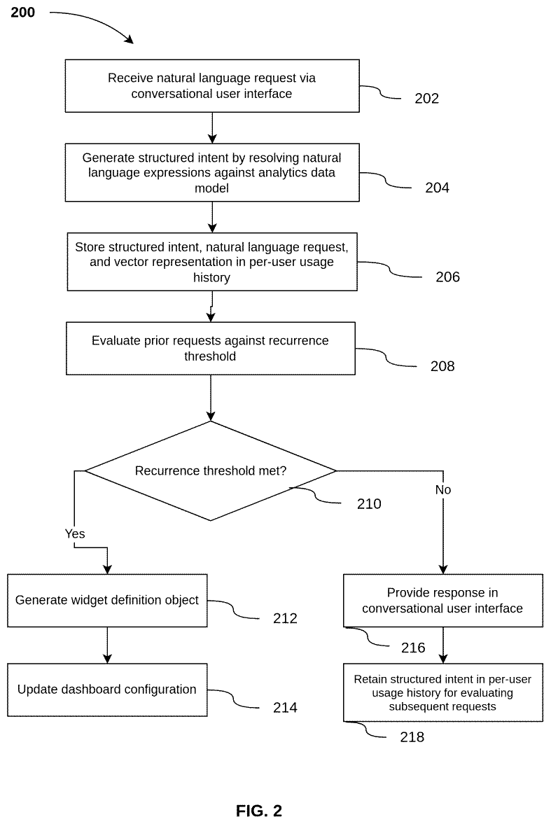

An example is provided below to illustrate the operation of the system environment 100 while embodiments are further explained in conjunction with FIG. 2 through FIG. 6. In the example operation of the system environment 100, a user associated with a tenant of the multi-tenant software platform submits a natural language request in a first session that states “show me open tickets assigned to my team today” via the conversational user interface 108 on the client device 102. The NLP engine 110 generates a structured intent from the natural language request by resolving the natural language expressions against the analytics data model 118. Resolving natural language expressions against the analytics data model 118 refers to the process by which the NLP engine 110 maps each natural language expression in the natural language request to a corresponding identifier defined in the analytics data model 118 through schema-grounded semantic parsing. Thus, the metric type is mapped to a measure identifier, the one or more filter conditions are mapped to one or more-dimension identifiers and associated dimension value identifiers, the time window is mapped to a time range identifier, and the scope is mapped to a tenant identifier. In the example above, “show me open tickets assigned to my team today”, the NLP engine 110 resolves the natural language request to the structured intent comprising one or more identifiers defined in the analytics data model 118. In the example above, this includes the metric type of ticket_count, the filter condition of status equal to OPEN and the assignee equal to the user's team, the time window of current_day, and the scope of the tenant identifier associated with the user. The promotion engine 112 stores the structured intent, the natural language request, and the vector representation of the natural language request in the per-user usage history.

The user may submit natural language requests reflecting the same underlying analytical need across subsequent user sessions using different wording such as “how many tickets are open for my team” in a second session and “open ticket count for today” in a third session. The NLP engine 110 generates the structured intent from each natural language request by resolving each request against the analytics data model 118. During the second session the NLP engine 110 resolves this request “how many tickets are open for my team” against the analytics data model 118 and produces an identical structured intent comprising measure identifier ticket_count, dimension identifier status with dimension value identifier OPEN, dimension identifier assignee with dimension value identifier corresponding to the user's team, time range identifier current_day, and tenant identifier associated with the user. Similarly, during the third session the user submits “open ticket count for today” using further different wording. The NLP engine 110 again produces the same structured intent comprising the same identifiers. Despite the three requests using different natural language expressions, the NLP engine 110 maps each to identical identifiers defined in the analytics data model 118, enabling the promotion engine 112 to recognize all three requests as expressions of the same recurring analytical need.

The promotion engine 112 evaluates the one or more prior requests stored in the per-user usage history against the current structured intent to determine whether the recurrence threshold is met. In one embodiment, the promotion engine 112 may determine recurrence using the similarity score between the vector representation of the current natural language request and vector representations of the prior natural language requests stored in the per-user usage history. In the example above, the promotion engine 112 evaluates the semantic similarity between the natural language requests across the three sessions using vector representations stored in the per-user usage history. The vector representation of “show me open tickets assigned to my team today” and the vector representation of “how many tickets are open for my team” are computed to have a high similarity score that meets or exceeds a configurable similarity threshold, reflecting that both requests express the same underlying analytical need despite using different words to describe the ticket status, assignee, and time context. Similarly, the vector representation of “open ticket count for today” is computed to have a high similarity score against each of the prior two requests, as all three requests encode the same semantic intent, which is ‘a count of open tickets assigned to the user's team for the current day’. In such a scenario, the promotion engine 112 increments the recurrence count for each prior request whose similarity score meets the configurable similarity threshold. After the third session, the recurrence count meets the recurrence threshold (for example, the recurrence threshold of three) and the promotion engine 112 proceeds to generate the widget definition object based on the structured intent. In an embodiment, the promotion engine 112 may use comparison of the one or more identifiers of the current structured intent against the one or more identifiers of the structured intents of the prior requests. The promotion engine 112 determines that the prior requests correspond to the same recurring analytical need despite the difference in wording of the natural language requests. In one illustrative implementation using cosine similarity, the configurable similarity threshold may be set to about 0.85, such that semantically similar natural language requests expressed with different wording are determined to correspond while dissimilar requests are excluded. The configurable similarity threshold may be predetermined, tenant-specific, administrator-configurable, or learned from historical request patterns.

When the recurrence threshold is met, the promotion engine 112 generates a widget definition object and updates the dashboard configuration of the user to include the widget definition object. On a subsequent dashboard access, the personalized analytics dashboard 116 renders a widget by executing a query referenced in the widget definition object against the analytics backend 114 without re-executing the natural language processing engine 110.

The disclosed method and system provide technical advances in computational efficiency, memory utilization, latency reduction, and session-persistent behavioral intelligence. These advances are enabled by the architecture of the promotion engine 112 operating as a persistent behavioral layer that converts ephemeral per-request conversational interactions into normalized structured representations accumulated across user sessions independently of session termination. As recurring analytical needs are detected from this accumulated history, the system automatically triggers dashboard configuration without requiring repeated natural language processing, manual configuration, or developer intervention. The first advance is session-termination-independent recurrence detection. The promotion engine 112 stores the structured intent, the natural language request, and the vector representation of the natural language request in the per-user usage history maintained across user sessions independently of session termination. This persistent accumulation enables the promotion engine 112 to evaluate one or more prior requests of the user against the current structured intent using either a similarity score between vector representations or a comparison of one or more identifiers of the structured intent, detecting a recurring analytical need that no individual session-scoped system can detect.

The second advance is schema-grounded normalization enabling cross-session comparison without re-parsing. The NLP engine 110 resolves natural language expressions against the analytics data model 118 into one or more identifiers defined in the analytics data model 118 on each request. Because different natural language expressions reflecting the same analytical need resolve to identical identifiers, the promotion engine 112 can compare structured intents of prior requests against the current structured intent directly from stored identifiers without re-executing the natural language processing engine against prior requests. This reduces memory consumption and eliminates repeated NLP pipeline execution for comparison purposes.

The third advance is elimination of repeated NLP pipeline execution on subsequent dashboard accesses. When the recurrence threshold is met and the widget definition object is generated, subsequent accesses to the personalized analytics dashboard 116 retrieve data by executing the query referenced in the widget definition object against the analytics backend 114 without re-executing the natural language processing engine 110. Each subsequent dashboard access therefore bypasses the full NLP pipeline, reducing per-session computational overhead and response latency compared to prior art systems that require a new natural language processing cycle for each data retrieval operation.

FIG. 1B illustrates a block diagram of the server 104 of FIG. 1A, according to an embodiment of the present disclosure. Referring to FIG. 1B, the server 104 comprises a processor 104A, a memory 104B, a database 104C, and an input/output (I/O) interface 104D. The processor 104A may be configured to execute instructions stored in the memory 104B. The processor 104A may include one or more central processing units (CPUs) or other processing elements.

The memory 104B stores instructions and data utilized by the processor 104A. The memory 104B may include volatile memory such as random access memory (RAM) or non-volatile memory such as flash memory. The memory 104B stores the NLP engine 110, the promotion engine 112, and the analytics backend 114 as executable modules executed by the processor 104A. The memory 104B further stores the analytics data model 118 as a data module accessible to the NLP engine 110, the promotion engine 112, and the analytics backend 114. The NLP engine 110 comprises a semantic layer including an intent classifier 110A, a domain classifier 110B, an entity classifier 110C, a metric matcher 110D, and a time parser 110E, the architecture of which is further described with reference to FIG. 1C. The promotion engine 112 is configured to operate as a persistent behavioral layer that stores the structured intent, the natural language request, and the vector representation of the natural language request in the per-user usage history maintained across user sessions. Further, the promotion engine 112 is configured to evaluate one or more prior requests of the user against the structured intent to determine whether a recurrence threshold is met independently of termination of any individual user session. The analytics backend 114 comprises a query builder 114A and an Elasticsearch adapter 114B, the architecture of which is further described with reference to FIG. 1D.

The database 104C is stored in or is accessible through memory 104B. The database 104C may be configured to store the per-user usage history, structured intents, widget definition objects, and dashboard configurations associated with one or more users of the multi-tenant software platform. Each record stored in the per-user usage history in the database 104C comprises a structured intent, the natural language request from which the structured intent was derived, the vector representation of the natural language request, and a timestamp corresponding to the time at which the natural language request was received via the conversational user interface 108. The per-user usage history persists across user sessions such that structured intents and vector representations corresponding to prior requests of the user from earlier user sessions remain available to the promotion engine 112 for evaluation against the current structured intent independently of session termination. In an embodiment, the database 104C maintains a dashboard index storing dashboard configuration records and a widget index storing widget definition objects, each mapped to a user identifier corresponding to the user for whom the widget definition object was generated.

The I/O interface 104D facilitates communication between the server 104 and the client device 102 over the network 106. The I/O interface 104D may be configured to receive natural language requests from the client device 102 via the conversational user interface 108. The I/O interface 104D may be further configured to transmit a widget definition object or an updated dashboard configuration to the client device 102 such that the personalized analytics dashboard 116 renders the widget on a subsequent dashboard access by executing a query referenced in the widget definition object against the analytics backend 114 without re-executing the natural language processing engine 110.

FIG. 1C illustrates a block diagram of the NLP engine 110 of FIG. 1A, according to an embodiment of the present disclosure. Referring to FIG. 1C, the NLP engine 110 comprises a semantic layer including an intent classifier 110A, a domain classifier 110B, an entity classifier 110C, a metric matcher 110D, and a time parser 110E. The NLP engine 110 operates as a per-request semantic layer that resolves each natural language request to a structured intent by mapping natural language expressions to one or more identifiers defined in the analytics data model 118. The output of the NLP engine 110 is a structured representation, referred to herein as a Semantic JSON, that encodes the natural language request as one or more identifiers defined in the analytics data model 118. The Semantic JSON produced by the NLP engine 110 corresponds to the structured intent passed to the promotion engine 112 for storage in the per-user usage history and to the analytics backend 114 for query construction and execution as described with reference to FIG. 1D.

The intent classifier 110A may be configured to identify the query type of the natural language request by classifying the natural language request against a set of supported query types defined in the analytics data model 118. The supported query types correspond to aggregation operations applicable to operational entities within the multi-tenant software platform, including count, sum, and average operations. The query type identified by the intent classifier 110A is passed to the metric matcher 110D for resolution against the analytics data model 118. In example 1, the user submits “how many processes were completed today,” the intent classifier 110A identifies the query type as a count operation and passes it to the metric matcher 110D.

The domain classifier 110B may be configured to identify the domain of the natural language request by resolving the subject of the request against the organizational scope of the tenant. The domain identified by the domain classifier 110B contributes to the scope field of the structured intent by confirming the relevant portion of the tenant's data model against which the request is evaluated. In the example above, the domain classifier 110B resolves the subject “processes” to the process management domain within the scope of the tenant identifier tenant_X and passes the scope to the metric matcher 110D.

The entity classifier 110C, which in some implementations operates as a named entity recognition extractor (NER), may be configured to identify one or more entity values in the natural language request comprising the operational entity, one or more associated attribute values, and temporal expressions. The entity classifier 110C passes the identified attribute values to the metric matcher 110D as filter conditions and passes the temporal expressions to the time parser 110E for normalization. In the example above, the entity classifier 110C identifies the attribute value “completed” as a filter condition and the temporal expression “today” as a time expression, passing each to the respective downstream sub-component.

The metric matcher 110D may be configured to receive the query type from the intent classifier 110A, the scope from the domain classifier 110B, and the filter conditions from the entity classifier 110C, and to resolve each against the analytics data model 118 to produce the corresponding identifiers of the structured intent. The metric matcher 110D maps the query type to a measure identifier, the filter conditions to one or more-dimension identifiers and associated dimension value identifiers, and the scope to a tenant identifier in the analytics data model 118. In the example above, the metric matcher 110D maps the count operation to measure identifier process_count, the attribute value “completed” to dimension identifier status with dimension value identifier COMPLETED, and the tenant context to tenant identifier tenant_X.

The time parser 110E may be configured to receive temporal expressions from the entity classifier 110C and normalize the temporal expressions to time range identifiers defined in the analytics data model 118 using temporal normalization techniques. Temporal normalization resolves variant natural language time expressions to a standard canonical form such that different expressions representing the same time period resolve to the same time range identifier. In the example above, the time parser 110E normalizes the temporal expression “today” to time range identifier current_day. The natural language request “how many processes were completed today” submitted in the first session and the natural language request “show me today's completed process count” submitted in a subsequent session both produce a time range identifier of current_day after temporal normalization, enabling the promotion engine 112 to recognize the time window as identical across both natural language requests independently of the difference in wording.

The NLP engine 110 combines the output of the metric matcher 110D and the time parser 110E to produce the structured intent comprising one or more identifiers defined in the analytics data model 118 including measure identifier process_count, dimension identifier status, dimension value identifier COMPLETED, time range identifier current_day, and tenant identifier tenant_X. The structured intent is encoded as a Semantic JSON and passed to the promotion engine 112 for storage in the per-user usage history alongside the natural language request and the vector representation of the natural language request, and to the analytics backend 114 for query construction and execution as described with reference to FIG. 1D. The analytics backend 114 may further validate the Semantic JSON, for example using a JSON validator, prior to query construction.

In an embodiment the NLP engine 110 may apply template-based slot filling in which the natural language request is matched against predefined query templates with slots corresponding to the metric type, the one or more filter conditions, the time window, and the scope. The NLP engine 110 may alternatively apply rule-based pattern matching over a domain vocabulary defined for the tenant, mapping recognized phrases to structured field values. In an embodiment the NLP engine 110 may submit the natural language request to a large language model (LLM) with a structured output prompt instructing extraction of the metric type, the one or more filter conditions, the time window, and the scope as a structured object in a machine-readable format. In some implementations, the natural language request is further converted into a semantic vector representation for recurrence evaluation using an embedding model associated with the NLP engine 110 or the promotion engine 112.

In an embodiment, the NLP engine 110 evaluates a confidence score for the structured intent generated from the natural language request. The confidence score reflects the degree to which the natural language request maps to the identifiers defined in the analytics data model 118. When the confidence score fails to meet a confidence threshold, the NLP engine 110 does not generate a structured intent and instead provides a clarification request in the conversational user interface 108 prompting the user to refine or restate the natural language request. The promotion engine 112 does not store the structured intent, the natural language request, or the vector representation in the per-user usage history when the NLP engine 110 provides the clarification request in response to the natural language request. The confidence evaluation ensures that only well-formed structured intents that reliably represent the user's analytical need are stored in the per-user usage history and evaluated against the recurrence threshold, preventing ambiguous or unresolvable requests from accumulating toward the recurrence threshold and generating the widget definition object that does not accurately reflect the user's recurring analytical need.

The confidence score is determined based on the certainty with which the intent classifier 110A assigns the natural language request to a supported query type, the certainty with which the entity classifier 110C identifies attribute values and temporal expressions corresponding to the filter conditions and time window of the structured intent, and whether all required identifier fields comprising the measure identifier, dimension identifiers, time range identifier, and tenant identifier can be populated from the natural language request. A natural language request that maps clearly and completely to all required identifier fields produces a high confidence score. A natural language request that is ambiguous, uses terminology not recognized in the analytics data model 118, or does not contain sufficient information to populate all required identifier fields produces a low confidence score, below the confidence threshold. In some implementations, the confidence threshold may be configurable and may, for example, be set in a range of about 0.75 to 0.90 depending on the desired sensitivity of intent mapping to the query type.

FIG. 1D illustrates a block diagram of the analytics backend 114 of FIG. 1A, according to an embodiment of the present disclosure. Referring to FIG. 1D, the analytics backend 114 comprises a query builder 114A and an Elasticsearch adapter 114B. The analytics backend 114 receives the structured intent from the promotion engine 112 and constructs and executes a query against an underlying data store to retrieve data for rendering on the personalized analytics dashboard 116 and for inclusion in the widget definition object.

The query builder 114A may be configured to receive the structured intent encoded as a Semantic JSON and construct a query against the underlying data store. The query builder 114A accesses the analytics data model 118 to resolve the one or more identifiers of the structured intent to the corresponding query parameters of the underlying data store. The query builder 114A constructs a query comprising the filter conditions, tenant scoping parameter, and temporal boundaries corresponding to the structured intent. In the example where the structured intent comprises measure identifier process_count, dimension identifier status, dimension value identifier COMPLETED, time range identifier current_day, and tenant identifier tenant_X, the query builder 114A constructs a query retrieving the count of records where the request status is COMPLETED, the tenant identifier matches tenant_X, and the date logged falls within the current day. The constructed query is passed to the Elasticsearch adapter 114B for execution.

The Elasticsearch adapter 114B may be configured to receive the constructed query from the query builder 114A and execute the query against the underlying data store. The Elasticsearch adapter 114B deploys the widget definition object to a widget index in the database 104C upon generation of the widget definition object by the promotion engine 112. The widget index stores widget definition objects mapped to user identifiers such that the personalized analytics dashboard 116 retrieves the widget definition objects corresponding to the authenticated user at render time.

In an embodiment, the personalized analytics dashboard 116 invokes the getData API provided by the analytics backend 114. The getData API receives the widget definition object as a payload comprising the widgetQuery field, the index field identifying the underlying data store, and the user identifier. The Elasticsearch adapter 114B executes the query referenced in the widgetQuery field against the data store identified by the index field and returns the retrieved data to the personalized analytics dashboard 116 for rendering in the widget without re-executing the natural language processing engine 110. The Elasticsearch adapter 114B re-executes the query at a configured refresh interval determined by the time range identifier of the structured intent from which the widget definition object was generated. The widget definition object generated from the structured intent comprising a shorter time range identifier is refreshed more frequently than the refresh interval assigned to the widget definition object generated from the structured intent comprising a longer time range identifier, ensuring that the widget displays current operational data appropriate to the time window of the metric being monitored.

In the example above, the Elasticsearch adapter 114B executes the query constructed by the query builder 114A and retrieves a count of 20 completed processes for the current day within the scope of tenant identifier tenant_X. The retrieved count is returned to the conversational user interface 108 as a conversational response when the recurrence threshold has not been met. Further, the retrieved count is rendered as a key performance indicator (KPI) widget value on the personalized analytics dashboard 116 when the widget definition object has been generated and deployed to the widget index on a subsequent dashboard access, without reprocessing the natural language processing engine 110.

In some implementations, when the NLP engine 110 determines that the natural language request is only partially parsed, the server 104 may generate a clarification prompt identifying one or more unresolved elements of the request, including a metric, a scope, a filter condition, or a time range, and may defer generation of the structured intent until the unresolved elements are clarified. In some implementations, where a partial structured intent can still be generated, the server 104 may process the resolved portion and mark one or more unresolved fields as incomplete pending user clarification. If the analytics backend 114 is unavailable, times out, or returns an execution error, the server 104 may suppress widget generation or rendering for the affected request, store an error state associated with the request or the widget definition object, and present an error notification or retry option through the conversational user interface 108 or the personalized analytics dashboard 116.

FIG. 2 illustrates a flowchart of a method 200 for automatically generating and rendering a widget on the personalized analytics dashboard based on recurring natural language requests, according to an embodiment of the present disclosure. The server 104 of the system environment 100 includes the one or more processors 104A, the memory 104B, and the I/O interface 104D, as described with reference to FIG. 1B. The memory 104B stores instructions that, when executed by the one or more processors 104A, cause the server 104 to perform the method 200. The server 104 may further include the database 104C within the memory 104B for storing data associated with the method 200. The steps of the method 200 are described with reference to the components of the system environment 100 in FIG. 1A, FIG. 1B, FIG. 1C, FIG. 1D, and the flow diagram of FIG. 2. Although the steps are shown in a sequence, the steps may be performed in other orders, and some steps may be performed concurrently.

The steps of the method 200 are illustrated by referring to the example 1 mentioned earlier. As described in the example 1, the user associated with the tenant of the multi-tenant software platform submits the natural language request “how many processes were completed today” via the conversational user interface 108 on the client device 102. The server 104 receives the natural language request over the network 106.

At step 202 of the method 200, the one or more processors 104A may be configured to receive the natural language request from the user via the conversational user interface 108 presented on the client device 102. The server 104 receives the natural language request from the client device 102 over the network 106. The natural language request allows the user to ask for operational or business data in everyday language, such as “how many processes were completed today,” without knowledge of database query languages, report building tools, or the underlying data structure of the analytics platform.

At step 204 of the method 200, the one or more processors 104A may be configured to generate a structured intent from the natural language request. The NLP engine 110 generates the structured intent by resolving the natural language expressions in the natural language request against the analytics data model 118 stored in the memory 104B. As described in FIG. 1A, the structured intent is a machine-readable representation of the natural language request in which the metric type, filter conditions, time window, and scope are each expressed using identifiers pre-defined in the analytics data model 118, such that the structured intent fields are drawn from a fixed set of permitted identifiers established for the tenant prior to receiving the natural language request.

In an embodiment, the structured intent comprises a metric type, one or more filter conditions, a time window, and a scope derived from a tenant or user context, each expressed as one or more identifiers defined in the analytics data model 118. For example, the metric type is a business measure being requested by the user, such as a count of records, a sum, or an average value associated with an operational entity. The one or more filter conditions are constraints that narrow the data to a relevant subset based on one or more attributes of the operational entity. For example, the user requesting open tickets assigned to a specific team applies filter conditions of status equal to OPEN and assignee equal to the user's team, narrowing the data from all tickets in the system to only those that are open and assigned to that team. Other examples of filter conditions include a priority equal to ‘HIGH’ to retrieve only high priority items, a category equal to BILLING to retrieve only billing-related records, or a resolution status equal to PENDING to retrieve only unresolved items.

The time window is the time range over which the metric type is evaluated. For example, the user requesting completed processes for the current day applies a time window of current_day, while the user requesting ticket volume over the past week applies a time window of current_week. The time window constrains the query to return only data logged or updated within the specified time range, ensuring the metric value reflects current operational activity rather than all historical records.

The scope is the organizational boundary within which the data is retrieved, derived from the tenant or user context associated with the natural language request. In a multi-tenant software platform, each tenant operates within an isolated data environment. The scope ensures that the user associated with tenant identifier tenant_X retrieves data only from the records belonging to that tenant, and the user with a team-level scope retrieves data only from records assigned to that team. This prevents cross-tenant data access and ensures the metric value is relevant to the user's organizational context.

In some implementations, the widget definition object generated from the structured intent is stored in association with the tenant identifier and the user identifier, such that the widget definition object is retrievable only within the isolated data environment of the corresponding tenant. Similarly, the dashboard configuration and any widget index used to retrieve the widget definition objects are scoped by tenant identifier, thereby preventing a widget generated for a first tenant from being rendered in a personalized dashboard associated with a different tenant. This tenant-scoped storage and retrieval of the widget definition objects, further enforces multi-tenant isolation in the personalized analytics dashboard.

In an embodiment, the NLP engine 110 comprises a semantic layer including an intent classifier 110A, a domain classifier 110B, an entity classifier 110C, a metric matcher 110D, and a time parser 110E as described with reference to FIG. 1C. The intent classifier 110A classifies the natural language request against the set of supported query types defined in the analytics data model 118 to identify the query type of the natural language request. The supported query types correspond to aggregation operations applicable to operational entities within the multi-tenant software platform, including count, sum, and average operations. The query type identified by the intent classifier 110A is passed to the metric matcher 110D for resolution against the analytics data model 118. As used herein, resolving a natural language expression against the analytics data model 118 comprises matching or mapping the natural language expression to a corresponding canonical identifier, field, aggregation type, attribute value, or time range representation defined in the analytics data model 118, such that the output is a machine-readable structured intent rather than unstructured text. The domain classifier 110B resolves the subject of the natural language request against the organizational scope of the tenant and passes the resolved scope to the metric matcher 110D to contribute to the scope field of the structured intent. The entity classifier 110C identifies one or more entity values in the natural language request comprising the operational entity, one or more associated attribute values, and temporal expressions. The entity classifier 110C passes the identified attribute values to the metric matcher 110D as filter conditions and passes the temporal expressions to the time parser 110E for normalization. The metric matcher 110D receives the query type from the intent classifier 110A, the scope from the domain classifier 110B, and the filter conditions from the entity classifier 110C, and resolves each against the analytics data model 118 to produce the one or more identifiers of the structured intent. The time parser 110E receives temporal expressions from the entity classifier 110C and normalizes the temporal expressions to time range identifiers defined in the analytics data model 118. The NLP engine 110 combines the output of the metric matcher 110D and the time parser 110E to produce the structured intent encoded as a Semantic JSON and passes the structured intent to the promotion engine 112 and to the analytics backend 114 for query construction and execution as described with reference to FIG. 1D.

For example, where the natural language request is ‘show me open tickets assigned to my team today,’ the intent classifier 110A may identify a supported query type corresponding to a count operation, the domain classifier 110B may identify the tenant-specific team scope, the entity classifier 110C may identify ‘tickets’ as an operational entity and ‘open’ as an attribute value, and the time parser 110E may normalize ‘today’ to a predefined time range identifier. The metric matcher 110D maps these extracted elements to corresponding identifiers defined in the analytics data model 118, such as an entity identifier for tickets, a status identifier corresponding to open, a scope identifier corresponding to the team, and a time range identifier corresponding to the current day. The resulting structured intent may then be encoded as a Semantic JSON specifying the identified aggregation type, entity identifier, filter identifiers, scope identifier, and time range identifier.

In an embodiment, the NLP engine 110 may apply template-based slot filling in which the natural language request is matched against predefined query templates with slots corresponding to the metric type, the one or more filter conditions, the time window, and the scope. The NLP engine 110 may alternatively apply rule-based pattern matching over a domain vocabulary defined for the tenant, mapping recognized phrases to structured field values. In an embodiment the NLP engine 110 may submit the natural language request to a large language model (LLM) with a structured output prompt instructing extraction of the metric type, the one or more filter conditions, the time window, and the scope as a structured object in a machine-readable format.

In an embodiment, the NLP engine 110 evaluates the confidence score for the structured intent generated from the natural language request. The confidence score reflects the degree to which the natural language request maps to the identifiers defined in the analytics data model 118. When the confidence score fails to meet the confidence threshold, the NLP engine 110 does not generate a structured intent and instead provides a clarification request in the conversational user interface 108 prompting the user to refine or restate the natural language request. The promotion engine 112 does not store the structured intent, the natural language request, or the vector representation of the natural language request in the per-user usage history when the NLP engine 110 provides the clarification request in response to the natural language request.

In an embodiment, the one or more guardrail policies define permitted data fields for each combination of tenant identifier and user role associated with the scope. The server 104 may be configured to retrieve the one or more guardrail policies from associated with the scope of the structured intent and evaluate whether the one or more identifiers of the structured intent reference data fields that are permitted under the retrieved guardrail policies. Validating the structured intent against the one or more guardrail policies prior to execution ensures that the user does not receive a conversational response or a persistent widget definition object for data that the user is not permitted to access within the scope.

In an embodiment the server 104 refrains from retaining the structured intent, the natural language request, and the vector representation of the natural language request in the per-user usage history when the structured intent does not satisfy the one or more guardrail policies. A structured intent that fails against guardrail validation is not stored in the per-user usage history in the database 104C and does not contribute toward the count of prior requests evaluated against the recurrence threshold. This ensures that repeated requests for non-permitted data fields do not accumulate toward the recurrence threshold and do not result in generation of the widget definition object for data that the user is not permitted to access.

Referring to example 2, the user submits “show me salary data for all employees today” via the conversational user interface 108. The one or more guardrail policies define that salary data fields are not permitted for the user's role under the scope of tenant identifier tenant_X. The structured intent does not satisfy the one or more guardrail policies. The server 104 provides a rejection response in the conversational user interface 108 and refrains from executing the structured intent against the analytics backend 114, from generating the widget definition object, and from retaining the structured intent, the natural language request, and the vector representation in the per-user usage history. In the subsequent session the user submits the same natural language request. The count of prior requests in the per-user usage history remains zero because the prior guardrail-failed structured intent was not retained. The recurrence threshold cannot be met for a natural language request that does not satisfy the one or more guardrail policies.

Referring to example 1, a guardrail policy associated with tenant identifier tenant_X defines that the user with a customer support operations manager role is permitted to access process count metrics, status-based fields, and time-based filters, such as counts of processes, process status values, and temporal ranges used to filter the counts. The same guardrail policy defines that salary data fields and employee personal information fields are not permitted for the user. The server 104 retrieves the guardrail policy and compares the one or more identifiers of the structured intent against the permitted data fields. The server 104 determines that the structured intent satisfies the one or more guardrail policies and passes the structured intent to the promotion engine 112.

In the example 1, the structured intent comprises one or more identifiers defined in the analytics data model 118 including a metric type of process_count representing the count of completed processes, a filter condition of status equal to COMPLETED, a time window of current_day, and a scope of tenant identifier tenant_X. The intent classifier 110A identifies the query type as a count operation. The domain classifier 110B resolves the subject “processes” to the process management domain within the scope of tenant identifier tenant_X. The entity classifier 110C identifies the attribute value “completed” as a filter condition and the temporal expression “today” as a time expression. The metric matcher 110D resolves the count operation to measure identifier process_count, the filter condition to dimension identifier status with dimension value identifier COMPLETED, and the scope to tenant identifier tenant_X. The time parser 110E normalizes the temporal expression “today” to time range identifier current_day. The NLP engine 110 encodes the structured intent as a Semantic JSON comprising measure identifier process_count, dimension identifier status, dimension value identifier COMPLETED, time range identifier current_day, and tenant identifier tenant_X.

The NLP engine 110 maps each field of the structured intent to a corresponding identifier in the analytics data model 118 using schema-grounded semantic parsing. Schema-grounded semantic parsing maps natural language expressions to identifiers defined in a structured data model rather than to free-form text. The NLP engine 110 normalizes temporal expressions in the natural language request to time range identifiers using temporal normalization techniques applied by the time parser 110E. The time parser 110E parses temporal expressions in the natural language request, interprets the temporal expressions relative to a reference time associated with request processing, and converts the temporal expressions into the canonical time range representation corresponding to the predefined time range identifier in the analytics data model 118. Accordingly, different natural language expressions representing the same time period are mapped to the same time range identifier. For example, the expressions “this week,” “during the current week,” and “since Monday” may each be normalized to a current_week time range identifier, depending on the reference time associated with request processing. Thus, the natural language request “show me escalated incidents this week” submitted in the first session and the natural language request “show me escalated incidents since Monday” submitted in the subsequent session may both produce the time range identifier current_week after temporal normalization by the time parser 110E, enabling the promotion engine 112 to recognize the time window as identical across both natural language requests.

At step 206 of the method 200, the one or more processors 104A may be configured to store the structured intent, the natural language request, and the vector representation of the natural language request in the per-user usage history maintained across user sessions. The promotion engine 112 stores each of these three elements as a record in the per-user usage history in the database 104C. The vector representation is a machine-readable numerical encoding of the natural language request generated using the semantic encoding technique, such as a sentence embedding model, a transformer-based encoder, an averaged token embedding representation, or a term-frequency inverse-document-frequency representation. The vector representation captures semantic features of the natural language request in a form that permits mathematical comparison with the vector representations of prior natural language requests stored in the per-user usage history. The promotion engine 112 computes the similarity score between the vector representation of the current natural language request and the vector representations of the prior natural language requests to determine whether the requests express a recurring analytical need. The per-user usage history persists across user sessions such that records stored in prior user sessions remain available to the promotion engine 112 for evaluation against the current structured intent at step 208.

In an embodiment, each record stored in the per-user usage history additionally comprises a timestamp corresponding to the time at which the natural language request was received via the conversational user interface 108. The timestamp enables the promotion engine 112 to support widget lifecycle management operations as described in reference to step 214.

Referring to example 1, in the first session, the user submits “how many processes were completed today.” The promotion engine 112 stores the structured intent comprising measure identifier process_count, dimension identifier status, dimension value identifier COMPLETED, time range identifier current_day, and tenant identifier tenant_X, alongside the natural language request “how many processes were completed today” and a vector representation of the natural language request, as a record in the per-user usage history in the database 104C.

At step 208 of the method 200, the one or more processors 104A may be configured to determine whether the recurrence threshold is met by evaluating one or more prior requests of the user stored in the per-user usage history against the structured intent. The promotion engine 112 retrieves one or more prior requests of the user from the per-user usage history in the database 104C. The per-user usage history maintained in the database 104C persists across user sessions independently of session termination such that prior requests of the user from earlier user sessions remain available to the promotion engine 112 for evaluation against the current structured intent.

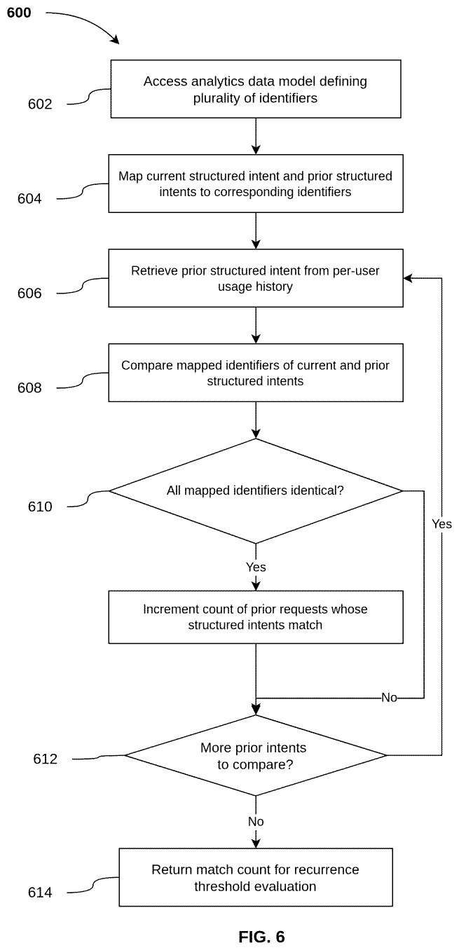

In one embodiment, the promotion engine 112 determines whether the recurrence threshold is met using the similarity score computed between the vector representation of the natural language request and one or more vector representations corresponding to the one or more prior requests. In an embodiment, the promotion engine 112 uses the comparison of the one or more identifiers of the structured intent of the natural language request against the one or more identifiers of structured intents of the one or more prior requests. Satisfaction of the recurrence threshold is indicative of a recurring analytical need of the user across user sessions. The recurrence detection processes are further described with reference to FIG. 5 and FIG. 6 respectively. Referring to the example 1, in the second session the user submits “show me today's completed process count.” The promotion engine 112 retrieves the prior request stored at step 206 from the first session and evaluates it against the current structured intent. The promotion engine 112 determines that the prior request corresponds to the recurring analytical need reflected in the current structured intent and increments the recurrence count by one.

In an embodiment, the promotion engine 112 applies cross-session weighting when evaluating prior requests against the recurrence threshold. The promotion engine 112 weights prior requests made in user sessions distinct from the current user session more heavily than prior requests made within the current user session, as explained in continued example 1 below. A user who submits the same natural language request multiple times within a single session contributes to a lower weighted count toward the recurrence threshold than the same number of requests submitted once per session across distinct sessions. Cross-session recurrence provides a stronger signal of a genuine recurring analytical need than same-session repetition, which may reflect exploratory behavior rather than a recurring operational need. The cross-session weighting embodiment applies to both the similarity scoring approach of FIG. 5 and the schema-grounded identifier matching approach of FIG. 6.

Referring back to the illustrative example 1, the user submits ‘how many processes were completed today’ three times within a single session. In an illustrative implementation, each request submitted within the same session contributes to a weight of 0.5 toward a recurrence threshold of 3. Accordingly, the three same-session requests produce a weighted count of 1.5, which does not satisfy the recurrence threshold. Under cross-session weighting, requests submitted in distinct sessions contribute to a higher weight than requests repeated within a single session. In a subsequent scenario, the same user submits ‘how many processes were completed today’ on a first day, ‘show me today's completed process count’ on a second day, and ‘completed processes so far today’ on a third day, each in a distinct session. In the illustrative implementation, each cross-session request contributes to a weight of 1.0, such that the three cross-session requests produce a weighted count of 3. Because the weighted count meets the recurrence threshold, the promotion engine 112 proceeds to step 210.

In an embodiment, the promotion engine 112 excludes the time range identifier from the match determination when applying the schema-grounded identifier matching approach of FIG. 6. In this context, the measure identifier identifies the quantitative measure requested, the dimension identifier identifies an attribute used for filtering or categorization, the dimension value identifier identifies a selected value of that attribute, the tenant identifier identifies the tenant context, and the time range identifier identifies the temporal scope of the request. As can be understood from example below, two structured intents are determined to correspond to the same recurring analytical need when the measure identifier, each dimension identifier and associated dimension value identifier, and the tenant identifier are identical, regardless of differences in the respective time range identifiers. The widget definition object generated when the recurrence threshold is met incorporates the time range identifier of the current structured intent. Referring to example 1, the user submits “how many processes were completed today” during one session and “how many processes were completed this week” during the subsequent session. The promotion engine 112 determines that the two structured intents correspond to the same recurring analytical need because the measure identifier process_count, the dimension identifier status, the dimension value identifier COMPLETED, and the tenant identifier tenant_X are identical. The difference in time range identifier between current_day and current_week does not prevent a determination of recurring analytical need. The widget definition object generated when the recurrence threshold is met incorporates the time range identifier current_week from the most recent request.

At step 210 of the method 200, the one or more processors 104A may be configured to evaluate whether the recurrence threshold is met. The recurrence threshold is a configurable value and may be set by a tenant administrator based on the operational requirements of the tenant. The promotion engine 112 compares the recurrence count returned at step 514 of FIG. 5 or step 614 of FIG. 6 against the recurrence threshold. When the recurrence count meets or exceeds the recurrence threshold, the promotion engine 112 determines that the recurrence threshold is met and the method 200 proceeds to step 212. When the recurrence count fails to meet the recurrence threshold, the method 200 proceeds to step 216.

In an embodiment, when the recurrence threshold is met the promotion engine 112 presents a recurrence notification to the user via the conversational user interface 108 prior to generating the widget definition object at step 212. The recurrence notification indicates to the user that the natural language request corresponds to the recurring analytical need and presents the user with an option to associate the corresponding widget definition object with the personalized analytics dashboard 116. With reference to example 1, upon determining that the recurrence count meets the recurrence threshold, the conversational user interface 108 presents the user with a notification stating, “You often look for this data, would you like to pin this report?” The promotion engine 112 generates the widget definition object at step 212 and updates the dashboard configuration at step 214 in response to receiving an affirmative response to the recurrence notification via the conversational user interface 108. When the user does not provide an affirmative response, the promotion engine 112 refrains from generating the widget definition object and the method 200 proceeds to step 216. This embodiment is distinct from the explicit instruction path described with reference to step 214, where the recurrence notification is system-initiated based on detected recurrence whereas the explicit instruction path is user-initiated independently of recurrence detection.

Referring to example 1, the user submits natural language requests “how many processes were completed today,” “show me today's completed process count,” and “completed processes so far today” across three distinct sessions, each determined to correspond to the same recurring analytical need. The promotion engine 112 determines that the recurrence count of three meets the recurrence threshold of three and the method 200 proceeds to step 212.

At step 212 of the method 200, the one or more processors 104A may be configured to generate the widget definition object when the recurrence threshold is met. The promotion engine 112 generates the widget definition object in response to the recurrence threshold being met at step 210. The widget definition object is a machine-readable structured artifact generated based on the structured intent.

In an embodiment, the widget definition object comprises a widget identifier, a widget type, a title, and a reference to a query executable by the analytics backend 114 to retrieve data corresponding to the structured intent. The following is an illustrative implementation specific example of a widget definition object. In some implementations, one or more fields of the widget definition object may include serialized structured content.
{
“id”: “0f803bf9-cba2-4f77-adaf-90f17c4083c2”,
“meta”: “{”type“:”KPI“,”title“:”Todays Completed Process“}”,
“widgetQuery”: “{“size”: 0, “_source”: false, “timeout”: “30000 ms”,“query”: {“bool”: {“must”:
[{“match”: {“requestStatus”: “COMPLETED”}}, {“match”:
{“tenantId.keyword”: “TENANTID_PLACEHOLDER”}}, {“range”: {“dateLogged”:
{“gte”: “now/d”, “lte”: “now”, “format”: “epoch_millis”}}}]}}}”,
“widgetType”: “KPI”,
“type”: “widget”,
“tenantId”: “a8109c17-7e79-5b59-74d0-07074a56c836”,
“userId”: “123”,
“index”: “activity”,
“dataType”: “Conv_UI_KPI”
}

The widget definition object above comprises a widget identifier field, a meta field, a widgetQuery field, a widgetType field, a type field, a tenant identifier field, a user identifier field, an index field, and a dataType field. The widget identifier field stores a unique identifier for the widget definition object within the tenant scope. The meta field stores the widget type and the title encoded in a machine-readable format. The widgetQuery field stores a reference to a query executable by the analytics backend 114, the query comprising the one or more filter conditions, the tenant identifier, and the time window of the structured intent expressed as query parameters. The widgetType field stores the widget type selected by the promotion engine 112 based on the metric type of the structured intent. The tenant identifier field stores the tenant identifier derived from the scope of the structured intent. The user identifier field stores the identifier of the user for whom the widget definition object was generated, enabling the analytics backend 114 to associate the widget definition object with the authenticated user's personalized analytics dashboard 116. The index field identifies the data store index used by the query builder 114A and the Elasticsearch adapter 114B to retrieve data for the widget. The dataType field stores a value identifying the widget definition object as originating from the conversational user interface 108, distinguishing the widget definition object from widget definition objects created through manual configuration.

In an embodiment, the promotion engine 112 selects the widget type from a set of supported widget types based on the metric type of the structured intent. A metric type representing a count-based measure results in the selection of a key performance indicator (KPI) counter widget type. A metric type representing a time-series measurement results in selection of a trend chart widget type. Different metric types result in selection of different widget types from the set of supported widget types. Referring to example 1, the metric type process_count represents a count-based measure. The promotion engine 112 selects the KPI counter widget type and generates a title of “Today's Completed Processes” derived from the metric type, the filter condition status equal to COMPLETED, and the time window current_day of the structured intent.

In an embodiment, the widget definition object incorporates the time range identifier of the current structured intent as the temporal boundary for the query referenced in the widgetQuery field. The refresh interval at which the analytics backend 114 re-executes the query is determined based on the time range identifier of the structured intent from which the widget definition object was generated. A widget definition object generated from a structured intent comprising the shorter time range identifier is assigned the shorter refresh interval than the refresh interval assigned to the widget definition object generated from a structured intent comprising the longer time range identifier. Thus, the widgets displaying data for shorter time windows are refreshed more frequently to reflect current operational data.

In an embodiment prior to writing the widget definition object to the dashboard configuration the promotion engine 112 compares the one or more identifiers of the widget definition object against the one or more identifiers of existing widget definition objects stored in the dashboard configuration of the user. When a semantically equivalent widget definition object already exists in the dashboard configuration, the promotion engine 112 refrains from writing a duplicate widget definition object. When no semantically equivalent widget definition object exists, the promotion engine 112 proceeds to write the widget definition object to the dashboard configuration. Duplicate detection prior to dashboard configuration update prevents redundant widget definition objects from accumulating in the dashboard configuration of the user and prevents duplicate widgets from being rendered on the personalized analytics dashboard 116.

With reference to example 1, the promotion engine 112 generates the widget definition object comprising a widget identifier of widget_001_tenant_X, a widget type of KPI counter, a title of “Today's Completed Processes,” and a reference to a query executable by the analytics backend 114 to retrieve the count of completed processes for the current day within the scope of tenant identifier tenant_X.

At step 214 of the method 200, the one or more processors 104A may be configured to update the dashboard configuration of the user to include the widget definition object. The promotion engine 112 writes the widget definition object to the dashboard configuration stored in the database 104C. The dashboard configuration associates the widget definition object with the user. On a subsequent dashboard access the personalized analytics dashboard 116 renders a widget by executing the query referenced in the widget definition object against the analytics backend 114 without reprocessing the natural language request by the natural language processing engine 110. The personalized analytics dashboard 116 is able to render the widget on a subsequent dashboard access without reprocessing the natural language request because the widget definition object persists a machine-readable query reference and associated rendering metadata in the dashboard configuration.

In an embodiment, the promotion engine 112 writes the widget definition object to the dashboard configuration by appending the widget definition object to an ordered list of widget definition objects associated with the user. In some implementations, dashboard placement is performed by a widget construction module and layout generator that append the widget definition object after existing widgets. The personalized analytics dashboard 116 renders widgets in the order of the list such that a newly appended widget definition object is rendered after existing widget definition objects without displacing or modifying the position of prior widget definition objects on the personalized analytics dashboard 116. In some implementations, the dashboard configuration further stores one or more user-specified layout parameters associated with the widget definition object, including a dashboard section identifier, a display order, a size parameter, or a position parameter. The widget construction module and layout generator may place the widget definition object according to the user-specified layout parameters when such parameters are available, and may otherwise append the widget definition object after existing widgets as a default placement behavior. In some implementations, the personalized analytics dashboard 116 provides a user-selectable control for repositioning or resizing the widget, and the updated position or size is written back to the dashboard configuration for use on a subsequent dashboard access.

In an embodiment the Elasticsearch adapter 114B deploys the widget definition object to the widget index in the database 104C upon generation by the promotion engine 112 such that the personalized analytics dashboard 116 retrieves the widget definition object from the widget index at render time using the user identifier stored in the widget definition object.

In an embodiment, the dashboard configuration places the widget definition object in a dashboard section determined by the dataType field of the widget definition object. A widget definition object with a dataType field value identifying the widget definition object as originating from the conversational user interface 108 is placed in a personalized section of the personalized analytics dashboard 116, distinct from sections presenting pre-configured business or operations widgets. Placement of conversationally generated widget definition objects in a dedicated personalized section enables the user to distinguish between automatically generated widgets and manually configured widgets on the personalized analytics dashboard 116.

In an embodiment, the dashboard configuration stores a promotion timestamp alongside the widget definition object. The promotion timestamp records the time at which the recurrence threshold was met, and the widget definition object was generated. The promotion engine 112 may be configured to use the promotion timestamp to support widget lifecycle management operations such as identifying widget definition objects that have not been accessed by the user for a defined period and presenting the user with an option to retain or remove the widget definition object from the personalized analytics dashboard 116. In some implementations, the personalized analytics dashboard 116 provides user-selectable ‘edit’ and ‘remove’ controls for each widget. Selection of the ‘edit’ control causes the server 104 to update one or more parameters of the widget definition object in the dashboard configuration, and selection of the ‘remove’ control causes the server 104 to remove the widget definition object from the dashboard configuration such that the widget is not rendered on a subsequent dashboard access.

In an embodiment, the one or more processors 104A may be configured by the instructions to receive, via the conversational user interface 108, an explicit instruction from the user to add the current structured intent to the personalized analytics dashboard 116 as a persistent widget. The explicit instruction path is significant in scenarios where the user recognizes an analytical need immediately on a first request without waiting for the recurrence threshold to be met, where an operational need requires immediate dashboard visibility such as during an incident or time-sensitive workflow, where a metric is requested infrequently and the recurrence threshold may not be met through natural usage behavior, or where a new user has no accumulated per-user usage history and the recurrence-based path cannot yet be triggered. In response to the explicit instruction the server 104 may be configured to validate the current structured intent against the one or more guardrail policies defining permitted data fields and access rights associated with the scope prior to generating the widget definition object. The promotion engine 112 generates the widget definition object for the current structured intent and the server 104 updates the dashboard configuration of the user to include the widget definition object only when the current structured intent satisfies the one or more guardrail policies, independently of whether the recurrence threshold has been met. When the current structured intent does not satisfy the one or more guardrail policies, the server 104 may be configured to provide a rejection response in the conversational user interface 108 and refrain from generating the widget definition object.

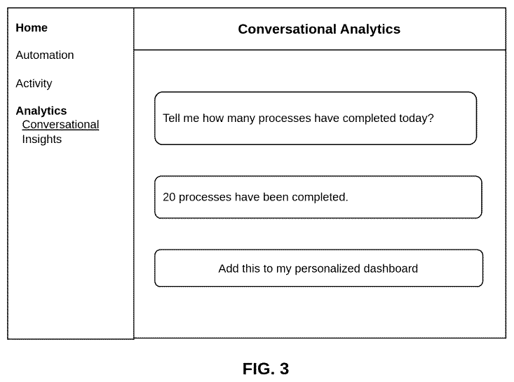

The explicit instruction path and the recurrence-based path together provide a complete dashboard configuration system in which recurring analytical needs are detected automatically from conversational behavior and immediate analytical needs are acted upon directly by the user. On a first session, the user submits “how many processes were completed today” and receives a conversational response of “20 processes have been completed.” The user then submits “add this to my personalized dashboard” via the conversational user interface 108. The scenario may be better understood in conjunction with the illustrative UI example of FIG. 3. The server 104 validates the current structured intent against the one or more guardrail policies and determines that the measure identifier process_count and the dimension identifier status with dimension value identifier COMPLETED are permitted for the user's role under the scope of tenant identifier tenant_X. The promotion engine 112 generates the widget definition object for the current structured intent and the server 104 updates the dashboard configuration of the user to include the widget definition object. The personalized analytics dashboard 116 renders the widget on the next access by the user without the recurrence threshold having been met.

At step 216 of the method 200, when the recurrence threshold is not met at step 210, the one or more processors 104A may be configured to provide a response to the natural language request in the conversational user interface 108. The server 104 executes the structured intent against the analytics backend 114 and provides the result in the conversational user interface 108. The conversational response at step 216 is a one-time result shown in the conversational user interface 108 that does not persist on the personalized analytics dashboard 116, addressing the analytical need of the user for the current session. Step 216 is significant in that the server 104 provides a useful response to the user at every interaction regardless of whether the recurrence threshold has been met, ensuring that the user receives value from each natural language request independently of the widget generation process. The one-time result at step 216 and the persistent widget definition object generated at step 212 represent two distinct outputs of the method 200. The one-time result serves the immediate analytical need of the user while the persistent widget definition object makes the recurring analytical need continuously available on the personalized analytics dashboard 116 without requiring the user to submit a natural language request on each subsequent access. The continued usefulness of the one-time result at step 216 provides a natural incentive for the user to submit recurring natural language requests, which in turn generates the conversational behavior signal that the promotion engine 112 evaluates against the recurrence threshold at step 208.

Continuing the example 1, on the first session, the user submits “how many processes were completed today.” The recurrence threshold of three has not been met. The server 104 executes the structured intent against the analytics backend 114 and provides a response of “20 processes have been completed today” in the conversational user interface 108. The user receives an immediate answer to the analytical need without any widget being generated or any dashboard configuration being updated.

At step 218 of the method 200, the one or more processors 104A may be configured by the instructions to retain the structured intent, the natural language request, and the vector representation of the natural language request in the per-user usage history. The promotion engine 112 retains all three elements in the per-user usage history in the database 104C such that the record is available for evaluating one or more subsequent requests of the user. The server 104 refrains from generating a widget definition object or updating the dashboard configuration until the recurrence threshold is met by a subsequent request of the user.

Referring to example 1, in the first session, the user submits “how many processes were completed today.” The recurrence count is zero and does not meet the recurrence threshold of three. The server 104 provides a response of “20 processes have been completed today” in the conversational user interface 108. The promotion engine 112 retains the structured intent, the natural language request, and the vector representation in the per-user usage history in the database 104C. No widget definition object is generated, and the dashboard configuration of the user is not updated. The user returns in subsequent sessions and submits the same natural language request in different wording, receiving a useful response each time, until the recurrence threshold is met and the promotion engine 112 generates the widget definition object at step 212.

The method disclsoed may be applied to count-based requests, such as “show me total purchase requests awaiting manager approval today,” and to non-count analytical requests, such as “show me average resolution time for escalated incidents this week.” The following examples illustrate operation of method 200 end to end. In a first illustrative example, the user associated with tenant identifier tenant_X submits, via the conversational user interface 108, the natural language request “show me total purchase requests awaiting manager approval today.” At step 202, the server 104 receives the natural language request. At step 204, the natural language processing engine 110 generates a structured intent from the natural language request. The intent classifier 110A identifies a supported query type corresponding to a count operation, the entity classifier 110C identifies “purchase requests” as an operational entity and “awaiting manager approval” as an attribute value, and the time parser 110E identifies “today” as a temporal expression. The metric matcher 110D maps these extracted elements to corresponding identifiers defined in the analytics data model 118.

In this example, the structured intent comprises a measure identifier purchase_request_count, a dimension identifier approval_status, a dimension value identifier awaiting_manager_approval, a time range identifier current_day, and a tenant identifier tenant_X. The structured intent may be encoded as a Semantic JSON or other machine-readable representation specifying the identified measure, filter, time range, and tenant scope.

At step 206, the promotion engine 112 stores the structured intent together with the natural language request and the vector representation of the natural language request in the per-user usage history. In an illustrative implementation, the vector representation is generated using a sentence embedding model and stored as a numerical semantic encoding suitable for similarity comparison. The per-user usage history for the same user already stores prior natural language requests from distinct sessions, including “how many purchase requests are awaiting manager approval today” and “today's purchase requests pending manager approval,” together with corresponding vector representations and structured intents.

At step 208, the promotion engine 112 evaluates the prior requests against the current structured intent to determine whether the recurrence threshold is met. In an illustrative implementation, the promotion engine 112 computes cosine similarity between the vector representation of the current natural language request and the vector representation of each prior natural language request, and applies a configurable similarity threshold of 0.85. For example, the similarity score between the current natural language request and the prior request “how many purchase requests are awaiting manager approval today” may be 0.92, and the similarity score between the current natural language request and the prior request “today's purchase requests pending manager approval” may be 0.89. Because both scores exceed the similarity threshold, each of those prior requests is treated as corresponding to the same recurring analytical need.

In an illustrative implementation in which the recurrence threshold is two prior matching requests, the recurrence threshold is satisfied. In some implementations, the promotion engine 112 may additionally confirm the recurring analytical need using the schema-grounded identifier matching approach, because the structured intents of the current request and the two prior requests resolve to the same measure identifier purchase_request_count, the same dimension identifier approval_status, the same dimension value identifier awaiting_manager_approval, and the same tenant identifier tenant_X.

At step 210, in response to determining that the recurrence threshold is met, the promotion engine 112 generates the widget definition object based on the structured intent. In an illustrative implementation, the widget definition object comprises a widget identifier, a widget type, a title, a tenant identifier, a user identifier, an index field, and a widgetQuery field referencing a query executable by the analytics backend 114. For example, the widget definition object may specify a widget type KPI, a title “Purchase requests awaiting manager approval today,” an index corresponding to purchase request records for tenant_X, and a widgetQuery referencing the measure identifier purchase_request_count, the dimension identifier approval_status, the dimension value identifier awaiting_manager_approval, and the time range identifier current_day.

At step 212, the server 104 updates the dashboard configuration of the user to include the widget definition object. On a subsequent dashboard access, the personalized analytics dashboard 116 retrieves the widget definition object and executes the query referenced in the widgetQuery field against the analytics backend 114 without reprocessing the original natural language request through the natural language processing engine 110. In this example, the analytics backend 114 may return a count value of 14 purchase requests awaiting manager approval for the current day, and the personalized analytics dashboard 116 renders a widget displaying “Purchase requests awaiting manager approval today: 14.”

In a second illustrative example, the user submits, via the conversational user interface 108, the natural language request “show me average resolution time for escalated incidents this week.” The natural language processing engine 110 identifies a supported query type corresponding to an average operation, identifies “incidents” as an operational entity, identifies “escalated” as an attribute value, and identifies “this week” as a temporal expression. The resulting structured intent comprises, for example, a measure identifier average_resolution_time, a dimension identifier incident_severity, a dimension value identifier escalated, a time range identifier current_week, and a tenant identifier tenant_X.

The promotion engine 112 stores the structured intent, the natural language request, and the vector representation in the per-user usage history and evaluates prior requests in the manner described above. Where the recurrence threshold is met, the promotion engine 112 generates a widget definition object corresponding to the structured intent and updates the dashboard configuration. On a subsequent dashboard access, the personalized analytics dashboard 116 renders a widget based on the stored widget definition object and query reference. In this example, the rendered widget may display “Average resolution time for escalated incidents this week: 6.4 hours.” This example illustrates that method 200 may be applied not only to count-based requests but also to non-count analytical requests.

The foregoing examples illustrate that method 200 converts recurring natural language analytical requests into persistent dashboard widgets by generating structured intents, storing vector-based request history, determining recurrence across sessions, generating widget definition objects, and rendering widgets on subsequent dashboard accesses without reprocessing the original natural language request.

FIG. 3 illustrates an exemplary conversational user interface of the system, according to an embodiment of the present disclosure. The conversational user interface 108 is presented on the client device 102 and provides a display area through which the user submits a natural language request and receives a response from the server 104. The conversational user interface 108 supports both a recurrence-based promotion path and an explicit instruction path for generating a widget definition object and updating the dashboard configuration of the user.

Referring to the step 202 of the method 200 in conjunction with FIG. 3, the conversational user interface 108 presents an input area through which the user submits a natural language request. The natural language request is submitted as a typed entry in the input area of the conversational user interface 108. The conversational user interface 108 transmits the natural language request to the server 104 over the network 106 for processing by the NLP engine 110 and the promotion engine 112.

In the example illustrated in FIG. 3, the user types the natural language request “Tell me how many processes have completed today so far?” into the input area of the conversational user interface 108. The conversational user interface 108 displays the natural language request in the conversational exchange area alongside a timestamp indicating the time at which the natural language request was submitted. Although the present example is described with reference to a text input, the user may also provide the natural language request through one or more other input modalities, including a voice input or non-text input modality. In such implementations, the non-text input is converted to a text representation or other machine-readable representation prior to processing by the natural language processing engine 110, such that the request may be processed in a substantially similar manner to a typed natural language request.

The server 104 processes the natural language request through the NLP engine 110 to generate a structured intent comprising one or more identifiers defined in the analytics data model 118 and passes the structured intent to the analytics backend 114. The query builder 114A constructs a query from the structured intent, and the Elasticsearch adapter 114B executes the query against the underlying data store to retrieve the result. The server 104 provides a response stating “20 processes have been completed” in the conversational user interface 108. The conversational user interface 108 renders the response in the conversational exchange area below the natural language request, alongside a timestamp.

In an embodiment, the conversational user interface 108 presents an explicit instruction element following the response. The explicit instruction element provides the user with an option to add the current structured intent to the personalized analytics dashboard 116 as a persistent widget independently of whether the recurrence threshold has been met. The explicit instruction element may be presented as a selectable control rendered in the conversational user interface 108 below the response. The user may activate the explicit instruction element to submit an explicit instruction to the server 104 to generate a widget definition object based on the current structured intent and update the dashboard configuration of the user to include the widget definition object. As illustrated, the conversational user interface 108 presents a selectable control labelled “Add this to my personalized dashboard” below the response in the conversational exchange area. The user activates the selectable control. The conversational user interface 108 transmits an explicit instruction to the server 104. The server 104 validates the current structured intent against the one or more guardrail policies and generates the widget definition object based on the current structured intent. The server 104 updates the dashboard configuration of the user to include the widget definition object.

In an embodiment, the conversational user interface 108 supports submission of the explicit instruction as a typed natural language command in the input area. The user may type a command such as “add this to my dashboard” in the input area of the conversational user interface 108 following a response. The NLP engine 110 may be configured to recognize the typed command as an explicit instruction to generate a widget definition object and update the dashboard configuration of the user, distinct from a natural language request directed to an analytical need.

In an embodiment, the conversational user interface 108 presents a recurrence notification to the user when the promotion engine 112 determines that the recurrence threshold is met. The recurrence notification is system-initiated based on detected recurrence and is distinct from the explicit instruction element described above, which is user-initiated. The recurrence notification indicates to the user that the natural language request corresponds to the recurring analytical need and presents the user with an option to associate the corresponding widget definition object with the personalized analytics dashboard 116. In example 1, upon the promotion engine 112 determining that the recurrence count meets the recurrence threshold, the conversational user interface 108 presents the recurrence notification, “You often look for this data, would you like to pin this report?” to the user. The promotion engine 112 generates the widget definition object and updates the dashboard configuration in response to receiving an affirmative response from the user via the conversational user interface 108. The user may provide the affirmative response by activating a selectable control presented alongside the recurrence notification or by submitting a typed affirmative command in the input area of the conversational user interface 108.

In an embodiment, the recurrence notification presented via the conversational user interface 108 is triggered through the similarity score path described with reference to FIG. 5. In this embodiment, a user submits “how many processes were completed today” in a first session and “show me completed process count for today” in a second session. The promotion engine 112 computes a similarity score between the vector representation of the current natural language request and the vector representation of the prior natural language request stored in the per-user usage history. The similarity score meets or exceeds the configurable similarity threshold because both natural language requests express the same underlying analytical need using different wording. The promotion engine 112 increments the recurrence count and continues evaluating additional prior requests stored in the per-user usage history. When the recurrence count meets or exceeds the recurrence threshold the promotion engine 112 determines that the recurrence threshold is met and the conversational user interface 108 presents the recurrence notification, “You often look for this data, would you like to pin this report?”, to the user. The promotion engine 112 generates the widget definition object based on the structured intent and updates the dashboard configuration of the user to include the widget definition object in response to receiving an affirmative response from the user via the conversational user interface 108. The widget is rendered on the personalized analytics dashboard 116 on a subsequent dashboard access by executing the query referenced in the widget definition object against the analytics backend 114 without re-executing the natural language processing engine 110.

In an embodiment, the conversational user interface 108 maintains a conversational history within the conversational exchange area displaying prior natural language requests submitted by the user and corresponding responses provided by the server 104 within the current session. The conversational history enables the user to review prior natural language requests and corresponding responses within the session. The conversational history is session-scoped and is distinct from the per-user usage history maintained in the database 104C, which persists across user sessions and stores the structured intent, the natural language request, and the vector representation of the natural language request for recurrence threshold evaluation by the promotion engine 112.

In an embodiment, the conversational user interface 108 is accessible through a navigation structure of the multi-tenant software platform. As seen from FIG. 3, the navigation structure provides access to one or more sections of the platform including a home section, an automation section, an activity section, and an analytics section. The conversational user interface 108 is accessible through the analytics section of the navigation structure. The analytics section may comprise a conversational analytics subsection and an insights subsection. The user navigates through the conversational analytics subsection to access the conversational user interface 108 and submit natural language requests. The navigation structure of the multi-tenant software platform presents menu items including Home, Automation, Activity, Analytics, Conversational, and Insights. The user selects the Conversational menu item under the Analytics section to access the conversational user interface 108.

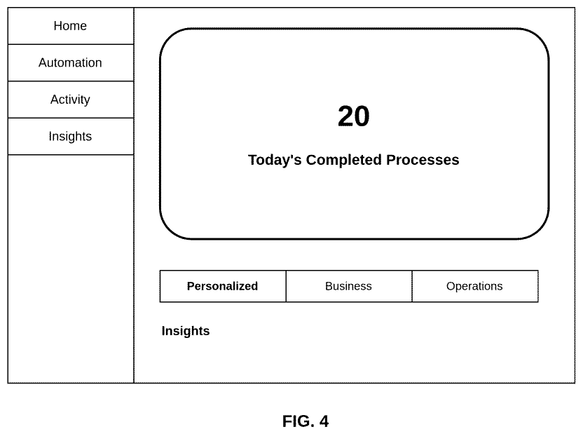

FIG. 4 illustrates an exemplary personalized analytics dashboard interface, according to an embodiment of the present disclosure. The personalized analytics dashboard 116 is presented on the client device 102 and displays widget definition objects associated with the dashboard configuration of the user. The personalized analytics dashboard 116 renders a widget based on the widget definition object generated by the promotion engine 112 on a subsequent dashboard access by executing the query referenced in the widget definition object against the analytics backend 114 without re-executing the natural language processing engine 110. The personalized analytics dashboard 116 comprises a plurality of dashboard sections. Each dashboard section presents widget definition objects of a corresponding category. In an embodiment, the plurality of dashboard sections comprises a personalized section, a business section, and an operations section. The personalized section presents widget definition objects generated automatically by the promotion engine 112 through the recurrence-based promotion path or the explicit instruction path. The business section and the operations section present widget definition objects configured through manual configuration workflows. In the example illustrated in FIG. 4, the personalized analytics dashboard 116 presents three tabs labelled Personalized, Business, and Operations. The widget definition object generated by the promotion engine 112 for the structured intent comprising one or more identifiers defined in the analytics data model 118 including metric type process_count, filter condition status equal to COMPLETED, time window current_day, and scope tenant identifier tenant_X is rendered in the Personalized tab of the personalized analytics dashboard 116.

In an, the personalized analytics dashboard 116 determines the dashboard section in which to render the widget based on the dataType field of the widget definition object. A widget definition object with a dataType field value identifying the widget definition object as originating from the conversational user interface 108 is rendered in the personalized section of the personalized analytics dashboard 116. The dataType field value distinguishes widget definition objects generated through the recurrence-based promotion path or the explicit instruction path from widget definition objects created through manual configuration workflows, enabling the personalized analytics dashboard 116 to place automatically generated widget definition objects in the personalized section without requiring manual placement by the user or an administrator. In the example herein, the widget definition object generated by the promotion engine 112 comprises a dataType field value of Conv_UI_KPI identifying the widget definition object as originating from the conversational user interface 108. The personalized analytics dashboard 116 reads the dataType field value and renders the widget in the Personalized tab.

The personalized analytics dashboard 116 renders the widget as a visual element displaying the result of the query referenced in the widget definition object and executed by the analytics backend 114. The visual element displays a metric value, a title, and a widget type corresponding to the widget identifier, the title, and the widget type fields of the widget definition object. The query builder 114A constructs the query referenced in the widgetQuery field and the Elasticsearch adapter 114B executes the query against the underlying data store and retrieves the current data for rendering in the visual element without re-executing the natural language processing engine 110. In the example of FIG. 4, the personalized analytics dashboard 116 renders the widget based on the widget definition object as a key performance indicator (KPI) counter displaying a metric value of 20, a title of “Today's Completed Processes”, and a widget type of KPI. The Elasticsearch adapter 114B executes the query comprising the filter condition requestStatus equal to COMPLETED, the tenant identifier, and the time range from the start of the current day to the current time and retrieves the count of 20 completed processes for rendering in the KPI counter.

In an embodiment, the widgetType field of the widget definition object drives the rendering framework of the personalized analytics dashboard 116 to select the appropriate widget layout and presentation for the metric type. In an example implementation, the widget is rendered by a front-end framework comprising a React-based component framework. The widget definition object with a widgetType field value of KPI causes the rendering framework to instantiate a key performance indicator layout displaying a single aggregated metric value with a title. The widget definition object with a widgetType field value corresponding to a time-series metric causes the rendering framework to instantiate a trend chart layout. The rendering framework determines the widget layout based on the widgetType field value without requiring a code deployment or release cycle, enabling new widget definition objects generated by the promotion engine 112 to be rendered on the personalized analytics dashboard 116 immediately upon being written to the dashboard configuration.

In an embodiment, the personalized analytics dashboard 116 renders the widget in accordance with the widget definition object without requiring a code deployment or release cycle. The dashboard configuration of the user stored in the database 104C is read by the personalized analytics dashboard 116 at render time. The personalized analytics dashboard 116 retrieves the widget definition object from the widget index in the database 104C using the user identifier stored in the widget definition object and instantiates the widget based on the widget type, the title, and the query referenced in the widgetQuery field. The dataType field value Conv_UI_KPI identifies the widget definition object as a conversationally generated widget definition object, enabling the personalized analytics dashboard 116 to distinguish conversationally generated widget definition objects from manually configured widget definition objects and apply the appropriate rendering path.

In an embodiment, the personalized analytics dashboard 116 refreshes the metric value displayed in the widget at a refresh interval determined by the time range identifier of the structured intent from which the widget definition object was generated. The Elasticsearch adapter 114B re-executes the query referenced in the widgetQuery field against the underlying data store at the refresh interval and retrieves current data for rendering in the widget without re-executing the natural language processing engine 110. A widget definition object generated from the structured intent comprising the shorter time range identifier is refreshed more frequently than the refresh interval assigned to the widget definition object generated from a structured intent comprising the longer time range identifier, ensuring that the widget displays current operational data appropriate to the time window of the metric being monitored. In the example of FIG. 4, the widget definition object generated from the structured intent comprising time range identifier current_day is refreshed at an interval appropriate for a daily metric, ensuring that the count of 20 completed processes reflects current data throughout the day on the personalized analytics dashboard 116.

FIG. 5 illustrates a flowchart of a process 500 of the method 200 for determining recurrence of user requests using similarity scoring, according to an embodiment of the present disclosure. The process 500 is performed by the promotion engine 112 using the processor 104A as one embodiment of the recurrence detection step at step 208 of the method 200. The process 500 is particularly advantageous in scenarios where users express the same analytical need using varied or informal natural language across sessions, where the exact wording of requests differs significantly between sessions such that identifier-based matching may not recognize the underlying similarity, and where the system is deployed in environments serving users with diverse linguistic patterns or terminology preferences. By operating vector representations of natural language expressions rather than on structured identifiers, the process 500 enables the promotion engine 112 to detect recurring analytical needs based on semantic proximity rather than structural identity.

At step 502 of the process 500, the promotion engine 112 accesses the vector representation of the current natural language request stored in the per-user usage history at step 206 of the method 200 alongside the structured intent and the natural language request. The vector representation encodes the semantic content of the natural language request in a form that enables computation of a similarity score between the current natural language request and prior natural language requests stored in the per-user usage history. In an embodiment, the per-user usage history stores both the natural language request and the vector representation of each prior request alongside the structured intent. Storing the natural language request alongside the vector representation enables the promotion engine 112 to retrieve and present prior natural language requests to the user in the recurrence notification presented via the conversational user interface 108 when the recurrence threshold is met.

At step 504 of the process 500, the promotion engine 112 retrieves the vector representation of a prior natural language request from the per-user usage history stored in the database 104C. The per-user usage history may contain vector representations corresponding to multiple prior requests made by the user across different user sessions. The promotion engine 112 tracks which prior natural language requests have been compared against the current natural language request during execution of the process 500.

At step 506 of the process 500, the promotion engine 112 computes a similarity score between the vector representation of the current natural language request and the vector representation of the retrieved prior natural language request. The similarity score reflects the degree of semantic similarity between the two natural language expressions. A higher similarity score indicates a greater degree of semantic proximity between the current natural language request and the prior natural language request, regardless of differences in the specific words or phrasing used in each request.

At step 508 of the process 500, the promotion engine 112 evaluates whether the similarity score meets or exceeds a configurable similarity threshold. The configurable similarity threshold is a value that may be set by a tenant administrator based on the operational requirements of the tenant. A lower similarity threshold results in broader matching that captures more varied expressions of the same analytical need. A higher similarity threshold results in narrower matching that requires greater semantic proximity between requests. When the similarity score meets or exceeds the configurable similarity threshold, the process 500 proceeds to step 510. When the similarity score does not meet the configurable similarity threshold, the process 500 proceeds to step 512.

As mentioned earlier, in some implementations, the similarity score may comprise cosine similarity, dot product similarity, or another vector-space similarity measure computed over the vector representations. Cosine similarity measures the angular distance between two vector representations independently of their magnitude, making it appropriate when the vector representations are generated by embedding models that produce variable-length or unnormalized vectors, such as averaged token embeddings, where differences in query length or token count would otherwise distort the similarity score. Cosine similarity may be used as the preferred measure in multi-tenant enterprise environments where natural language requests vary significantly in length and complexity across users, as it ensures that a short request such as “open tickets today” and a longer semantically equivalent request such as “can you show me the count of tickets currently open and assigned to my team for today” are scored based on semantic direction rather than query length. Dot product similarity measures both the angular distance and the magnitude of the vector representations and is appropriate when the vector representations are generated by models trained with a dot product objective, such as dense retrieval encoders, where the magnitude of the representation encodes information relevant to semantic relevance and cosine normalization would discard that information. Dot product similarity may be preferred when the analytics backend 114 employs a dense retrieval model specifically trained for domain-specific query matching within the tenant's operational vocabulary, where the magnitude of the vector representation carries additional semantic weight beyond directional similarity. In practice, the selection of the similarity measure is determined by the training objective of the embedding model used to generate the vector representations. A model trained with a cosine similarity objective produces vector representations for which cosine similarity is the correct measure, and a model trained with a dot product objective produces vector representations for which dot product similarity is the correct measure. In each case the similarity score reflects the degree of semantic proximity between the current natural language request and each prior natural language request retrieved from the per-user usage history as evaluated against the configurable similarity threshold at step 508 of the process 500.

At step 510 of the process 500, the promotion engine 112 increments a recurrence count. The recurrence count tracks the number of prior natural language requests whose similarity scores meet or exceed the configurable similarity threshold when compared against the current natural language request.

At step 512 of the process 500, the promotion engine 112 evaluates whether additional prior natural language requests remain in the per-user usage history for comparison against the current natural language request. When additional prior requests remain, the process 500 returns to step 504 to retrieve the next prior natural language request. The loop continues until all prior natural language requests in the per-user usage history have been compared against the current natural language request.

At step 514 of the process 500, the promotion engine 112 returns the recurrence count accumulated during the process 500. The recurrence count is evaluated against the recurrence threshold at step 210 of the method 200 to determine whether the promotion engine 112 proceeds to generate the widget definition object at step 212 or provides a conversational response and retains the structured intent, the natural language request, and the vector representation at steps 216 and 218.

The following example illustrates the operation of the process 500. The user associated with tenant identifier tenant_X submits the natural language request “how many processes were completed today” via the conversational user interface 108. At step 206 of the method 200 the promotion engine 112 stores the vector representation of the natural language request alongside the structured intent comprising measure identifier process_count, dimension identifier status, dimension value identifier COMPLETED, time range identifier current_day, and tenant identifier tenant_X, and the natural language request in the per-user usage history in the database 104C. In the subsequent session, the user submits “show me completed process count for today.” At step 504, the promotion engine 112 retrieves the vector representation of the prior natural language request “how many processes were completed today” from the per-user usage history. At step 506, the promotion engine 112 computes a similarity score between the vector representation of the current natural language request “show me completed process count for today” and the retrieved vector representation. The similarity score reflects the semantic proximity of the two natural language expressions and meets or exceeds the configurable similarity threshold because both requests express the same underlying analytical need using different wording. At step 508, the promotion engine 112 determines that the similarity score meets the configurable similarity threshold and at step 510 increments the recurrence count to one. The promotion engine 112 continues evaluating additional prior requests at step 512 until all prior requests in the per-user usage history have been compared. The recurrence count is returned at step 514 for evaluation against the recurrence threshold at step 210 of the method 200.

In an embodiment the promotion engine 112 applies cross-session weighting during the process 500 when evaluating the recurrence count against the recurrence threshold, as described at step 208 of the method 200. The promotion engine 112 weights prior requests made in user sessions distinct from the current user session more heavily than prior requests made within the current user session when incrementing the recurrence count at step 510. The cross-session weighting embodiment and the associated example are described at step 208 of the method 200, which description is incorporated herein by reference.

FIG. 6 illustrates a flowchart of a process 600 of the method 200 for determining recurrence of user requests using schema-grounded identifier matching, according to an embodiment of the present disclosure. The process 600 is performed by the promotion engine 112 using the processor 104A as a further embodiment of the recurrence detection step at step 208 of the method 200. The process 600 is particularly advantageous in scenarios where the analytics data model 118 defines a well-structured set of identifiers that unambiguously represent the analytical concepts relevant to the tenant, where precision of matching is important and the system must distinguish between analytically distinct requests that may be semantically similar in natural language expression, and where the per-user usage history contains structured intents generated from requests across varied time windows that should be recognized as recurring needs for the same underlying metric. By operating on mapped identifiers derived from the analytics data model 118, the process 600 enables the promotion engine 112 to determine recurrence with high precision based on structural identity of analytical intent rather than on linguistic similarity.

At step 602 of the process 600, the promotion engine 112 queries or accesses the analytics data model 118 stored in the database 104C. The analytics data model 118 defines the one or more identifiers comprising a measure identifier for the metric type, one or more-dimension identifiers and associated dimension value identifiers for the one or more filter conditions, a time range identifier for the time window, and a tenant identifier for the scope.

At step 604 of the process 600, the promotion engine 112 maps the metric type, the one or more filter conditions, the time window, and the scope of the structured intent of the current natural language request and of each of the one or more prior requests to corresponding identifiers of the one or more identifiers in the analytics data model 118. The mapping at step 604 transforms each field of the structured intent to the corresponding identifier defined in the analytics data model 118, enabling the promotion engine 112 to compare structured intents based on the mapped identifiers rather than on the original natural language expressions from which the structured intents were derived.

At step 606 of the process 600, the promotion engine 112 retrieves a prior structured intent from the per-user usage history stored in the database 104C. The per-user usage history may contain multiple structured intents corresponding to multiple prior requests made by the user across different user sessions.

At step 608 of the process 600, the promotion engine 112 compares the one or more identifiers of the structured intent of the current natural language request against the one or more identifiers of the retrieved prior structured intent. The promotion engine 112 evaluates whether the measure identifier, each dimension identifier and associated dimension value identifier, the time range identifier, and the tenant identifier of the prior structured intent are identical to those of the current structured intent. A prior request is determined to correspond to the recurring analytical need when the one or more identifiers are identical, regardless of differences in the natural language expressions from which the structured intents were derived. Two natural language requests such as “completed processes today” and “how many processes done so far today” that use different wording map to identical identifiers in the analytics data model 118 and are recognized as representing the same underlying analytical need.

At step 610 of the process 600, when the one or more identifiers are identical, the promotion engine 112 increments a recurrence count. When the one or more identifiers are not identical, the promotion engine 112 does not increment the recurrence count and proceeds to step 612.

At step 612 of the process 600, the promotion engine 112 evaluates whether additional structured intents corresponding to prior requests remain in the per-user usage history. When additional prior structured intents remain, the process 600 returns to step 606 to retrieve the next prior structured intent. The loop continues until all prior structured intents in the per-user usage history have been compared against the structured intent of the current natural language request.

At step 614 of the process 600, the promotion engine 112 returns the recurrence count for evaluation against the recurrence threshold at step 210 of the method 200.

In an embodiment, the process 600 may be performed using flexible time window matching as described at step 208 of the method 200. When flexible time window matching is applied, the time range identifier is excluded from the match determination at step 608. The promotion engine 112 evaluates whether the measure identifier, each dimension identifier and associated dimension value identifier, and the tenant identifier of the prior structured intent are identical to those of the current structured intent, without evaluating whether the time range identifier of the prior structured intent is identical to the time range identifier of the current structured intent. Two structured intents are determined to correspond to the same recurring analytical need when their measure identifier, each dimension identifier and associated dimension value identifier, and tenant identifier are identical, regardless of differences in the respective time range identifiers. The widget definition object generated when the recurrence threshold is met incorporates the time range identifier of the current structured intent. Flexible time window matching is advantageous in scenarios where a user monitors the same metric across varying time horizons across sessions, such that requests for the same operational measure over different periods are recognized as a recurring analytical need for that measure. Referring to example 1, the user submits “how many processes were completed today” during one session and “how many processes were completed this week” during a subsequent session. The promotion engine 112 determines that the two structured intents correspond to the same recurring analytical need because the measure identifier process_count, the dimension identifier status, the dimension value identifier COMPLETED, and the tenant identifier tenant_X are identical. The difference in time range identifier between current_day and current_week does not prevent a determination of recurring analytical need. The widget definition object generated when the recurrence threshold is met incorporates the time range identifier current_week from the most recent request.

In an embodiment, the promotion engine 112 applies cross-session weighting during the process 600 when evaluating the recurrence count against the recurrence threshold, as described at step 208 of the method 200. The promotion engine 112 weights prior structured intents made in user sessions distinct from the current user session more heavily than structured intents made within the current user session when incrementing the recurrence count at step 610. The cross-session weighting embodiment and the associated example are described at step 208 of the method 200, which description is incorporated herein by reference.

Machine readable storage including machine-readable instructions, when executed, to implement a method or realize an apparatus in any of the examples of the present application. Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language and combined with hardware implementations.

It should be understood that many of the functional units described in this specification may be implemented as one or more components, which is a term used to more particularly emphasize their implementation independence. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another but are to be considered separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

What is claimed is:

1. A computer-implemented method for automatically generating and rendering a widget on a personalized dashboard, the method comprising:
receiving, by one or more processors, via a conversational user interface presented on a client device, a natural language request from a user;
generating, by a natural language processing engine executed by the one or more processors, a structured intent from the natural language request by mapping natural language expressions in the natural language request to corresponding one or more identifiers defined in an analytics data model;
storing, by a promotion engine executed by the one or more processors, the structured intent, the natural language request, and a vector representation of the natural language request in a per-user usage history maintained across user sessions;
determining, by the promotion engine, whether a recurrence threshold is met by evaluating one or more prior requests of the user stored in the per-user usage history against the structured intent, wherein evaluating comprises at least one of:
computing a similarity score between the vector representation of the natural language request and the vector representation corresponding to each of the one or more prior requests, or
comparing the one or more identifiers of the structured intent of the natural language request against the one or more identifiers of the structured intent of each of the one or more prior requests,
wherein satisfaction of the recurrence threshold is indicative of a recurring analytical need of the user across user sessions, and wherein the evaluation is performed independently of termination of any individual user session;
in response to determining that the recurrence threshold is met, generating, by the promotion engine, a widget definition object based on the structured intent; and
updating, by the promotion engine, a dashboard configuration of the user to include the widget definition object such that, on a subsequent dashboard access, a widget is rendered by executing a query referenced in the widget definition object against an analytics backend without reprocessing the natural language request by the natural language processing engine.

2. The method of claim 1, wherein evaluating, based on the similarity score, whether the recurrence threshold is met comprises:
incrementing a recurrence count for each prior request of the one or more prior natural language requests when the similarity score of a corresponding prior natural language request meets or exceeds a configurable similarity threshold; and
determining that the recurrence threshold is met when the recurrence count meets or exceeds the recurrence threshold.

3. The method of claim 1, wherein evaluating, based on comparing of the one or more identifiers, whether the recurrence threshold is met, comprises:
querying the analytics data model defining the one or more identifiers comprising a measure identifier for a metric type, one or more-dimension identifiers and associated dimension value identifiers for one or more filter conditions, a time range identifier for a time window, and a tenant identifier for a scope;
comparing the one or more identifiers of the structured intent corresponding to the natural language request against the one or more identifiers of structured intents corresponding to the one or more prior requests; and
incrementing a recurrence count for each prior request of the one or more prior requests for which the one or more identifiers are identical to the one or more identifiers of the structured intent corresponding to the natural language request regardless of differences in the natural language expressions from which the structured intent of the natural language request and the structured intent of the one or more prior requests are derived.

4. The method of claim 3, wherein the time range identifier, which corresponds to the time window of the structured intent, is excluded from the comparison such that a prior request is determined to correspond to the structured intent when the measure identifier, each dimension identifier and associated dimension value identifier, and the tenant identifier are identical to those of the structured intent regardless of differences in the time range identifier, and wherein the widget definition object incorporates the time range identifier of the structured intent.

5. The method of claim 1, wherein the widget definition object comprises a widget identifier, a widget type, a title, and a reference to a query executable by the analytics backend to retrieve data corresponding to the structured intent.

6. The method of claim 5, wherein the widget type is selected from a set of supported widget types based on a metric type of the structured intent, such that different metric types result in selection of different widget types from the set.

7. The method of claim 1, further comprising, in response to determining that the recurrence threshold is met, presenting, via the conversational user interface, a recurrence notification to the user indicating that the natural language request corresponds to the recurring analytical need, wherein generating the widget definition object and updating the dashboard configuration are performed in response to receiving an affirmative response to the recurrence notification.

8. The method of claim 1, further comprising receiving, via the conversational user interface, one or more instructions from the user to add the structured intent to the personalized analytics dashboard as a persistent widget, and, in response generating the widget definition object and updating the dashboard configuration independently of whether the recurrence threshold has been met.

9. The method of claim 1, further comprising validating the structured intent against one or more guardrail policies defining permitted data fields and access rights associated with a tenant or user context prior to generating the widget definition object, wherein generating the widget definition object and updating the dashboard configuration are performed only when the structured intent satisfies the one or more guardrail policies, and wherein the structured intent is not retained in the per-user usage history when the structured intent does not satisfy the one or more guardrail policies.

10. The method of claim 1, further comprising, in response to determining that the recurrence threshold is not met, providing a response to the natural language request via the conversational user interface, and retaining the structured intent in the per-user usage history for evaluating against one or more subsequent requests of the user.

11. A system for automatically generating and rendering a widget on a personalized dashboard, the system comprising:
one or more processors; and
a memory storing instructions that, when executed by the one or more processors, cause the one or more processors to:
receive, via a conversational user interface presented on a client device, a natural language request from a user;
generate, by a natural language processing engine, a structured intent from the natural language request by mapping natural language expressions in the natural language request to corresponding one or more identifiers defined in an analytics data model;
store, by a promotion engine, the structured intent, the natural language request, and a vector representation of the natural language request in a per-user usage history maintained across user sessions;
determine, by the promotion engine, whether a recurrence threshold is met by evaluating one or more prior requests of the user stored in the per-user usage history against the structured intent, wherein evaluating comprises at least one of:
computing a similarity score between the vector representation of the natural language request and the vector representation corresponding to each of the one or more prior requests, or
comparing the one or more identifiers of the structured intent of the natural language request against the one or more identifiers of the structured intent of each of the one or more prior requests,
wherein satisfaction of the recurrence threshold is indicative of a recurring analytical need of the user across user sessions, and wherein the evaluation is performed independently of termination of any individual user session;
in response to determining that the recurrence threshold is met, generate, by the promotion engine, a widget definition object based on the structured intent; and
update, by the promotion engine, a dashboard configuration of the user to include the widget definition object such that, on a subsequent dashboard access, a widget is rendered by executing a query referenced in the widget definition object against an analytics backend without reprocessing the natural language request by the natural language processing engine.

12. The system of claim 11, wherein the instructions, when executed by the one or more processors, cause the one or more processors to evaluate, based on the similarity score, whether the recurrence threshold is met by:
incrementing a recurrence count for each prior request of the one or more prior natural language requests when the similarity score of a corresponding prior natural language request meets or exceeds a configurable similarity threshold; and
determining that the recurrence threshold is met when the recurrence count meets or exceeds the recurrence threshold.

13. The system of claim 11, wherein the instructions, when executed by the one or more processors, cause the one or more processors to evaluate, based on comparing of the one or more identifiers, whether the recurrence threshold is met by:
querying the analytics data model defining the one or more identifiers comprising a measure identifier for a metric type, one or more-dimension identifiers and associated dimension value identifiers for one or more filter conditions, a time range identifier for a time window, and a tenant identifier for a scope;
comparing the one or more identifiers of the structured intent corresponding to the natural language request against the one or more identifiers of structured intents corresponding to the one or more prior requests; and
incrementing a recurrence count for each prior request of the one or more prior requests for which the one or more identifiers are identical to the one or more identifiers of the structured intent corresponding to the natural language request regardless of differences in the natural language expressions from which the structured intent of the natural language request and the structured intent of the one or more prior requests are derived.

14. The system of claim 13, wherein the time range identifier, which corresponds to the time window of the structured intent, is excluded from the comparison such that a prior request is determined to correspond to the structured intent when the measure identifier, each dimension identifier and associated dimension value identifier, and the tenant identifier are identical to those of the structured intent regardless of differences in the time range identifier, and wherein the widget definition object incorporates the time range identifier of the structured intent.

15. The system of claim 11, wherein the widget definition object comprises a widget identifier, a widget type, a title, and a reference to a query executable by the analytics backend to retrieve data corresponding to the structured intent.

16. The system of claim 15, wherein the widget type is selected from a set of supported widget types based on a metric type of the structured intent, such that different metric types result in selection of different widget types from the set.

17. The system of claim 11, wherein the instructions, when executed by the one or more processors, cause the one or more processors to, in response to determining that the recurrence threshold is met, present, via the conversational user interface, a recurrence notification to the user indicating that the natural language request corresponds to the recurring analytical need, wherein generating the widget definition object and updating the dashboard configuration are performed in response to receiving an affirmative response to the recurrence notification.

18. The system of claim 11, wherein the instructions, when executed by the one or more processors, cause the one or more processors to receive, via the conversational user interface, one or more instructions from the user to add the structured intent to the personalized analytics dashboard as a persistent widget, and, in response generate the widget definition object and update the dashboard configuration independently of whether the recurrence threshold has been met.

19. The system of claim 11, wherein the instructions, when executed by the one or more processors, cause the one or more processors to validate the structured intent against one or more guardrail policies defining permitted data fields and access rights associated with a tenant or user context prior to generating the widget definition object, wherein generating the widget definition object and updating the dashboard configuration are performed only when the structured intent satisfies the one or more guardrail policies, and wherein the structured intent is not retained in the per-user usage history when the structured intent does not satisfy the one or more guardrail policies.

20. A non-transitory computer-readable medium storing instructions that, when executed by one or more processors, cause the one or more processors to:
receive, via a conversational user interface presented on a client device, a natural language request from a user;
generate, by a natural language processing engine, a structured intent from the natural language request by mapping natural language expressions in the natural language request to corresponding one or more identifiers defined in an analytics data model;
store, by a promotion engine, the structured intent, the natural language request, and a vector representation of the natural language request in a per-user usage history maintained across user sessions;
determine, by the promotion engine, whether a recurrence threshold is met by evaluating one or more prior requests of the user stored in the per-user usage history against the structured intent, wherein evaluating comprises at least one of:
computing a similarity score between the vector representation of the natural language request and the vector representation corresponding to each of the one or more prior requests, or
comparing the one or more identifiers of the structured intent of the natural language request against the one or more identifiers of the structured intent of each of the one or more prior requests,
wherein satisfaction of the recurrence threshold is indicative of a recurring analytical need of the user across user sessions, and wherein the evaluation is performed independently of termination of any individual user session;
in response to determining that the recurrence threshold is met, generate a widget definition object based on the structured intent; and
update a dashboard configuration of the user to include the widget definition object such that, on a subsequent dashboard access, a widget is rendered by executing a query referenced in the widget definition object against an analytics backend without reprocessing the natural language request by the natural language processing engine.
